(19) United States
(12) Patent Application Publication
(10) Pub. No.: US 2026/0320448 A1
(43) Pub. Date: Oct. 15, 2026

(54) System and method for autonomous generation and optimization of a multi-agentic AI system

(71) Applicant: Aixplain, Inc., San Jose, CA (US)

(72) Inventors: Kamer Ali YUKSEL, Munchen (DE); Hassan SAWAF, San Jose, CA (US)

(73) Assignee: Aixplain, Inc., San Jose, CA (US)

(21) Appl. No.: 19/467,218

(22) Filed: Feb. 2, 2026

Related U.S. Application Data
(60) Provisional application No. 63/753,184, filed on Feb. 3, 2025.

(51) Int. Cl. G06N 5/043

(52) U.S. Cl. CPC G06N 5/043

(57) ABSTRACT

A system and method for autonomous generation and optimization of multi-agent systems. The system receives an input comprising an idea description defining objectives for a target multi-agent system. The system generates a multi-agent system definition comprising a plurality of agent definition data structures. Each agent definition data structure comprises a backstory parameter expressed in natural language that defines an expertise domain, a behavioral context, and a decision-making rationale for a corresponding agent. The system generates qualitative evaluation criteria by analyzing the multi-agent system definition using a large language model. The qualitative evaluation criteria are derived without requiring human-specified evaluation parameters. The system iteratively optimizes the multi-agent system definition by generating hypothesis data comprising proposed modifications with rationale, synthesizing variants based on the proposed modifications, and evaluating the variants against the qualitative evaluation criteria. The system operates autonomously without human intervention until a termination condition is satisfied.

### PRIORITY PARAGRAPH

This document is a United States Non-provisional utility patent application under statute 35 U.S.C. 111(A). This document claims priority and benefit to a U.S. Provisional utility patent application that is identified by a Ser. No. 63/753,184 and that is titled “Autonomous Meta-Framework for Agentic AI Use-Case Generation, Implementation, and Execution”, and that was filed with the U.S. Patent and Trademark Office (USPTO) on Feb. 3, 2025. The above-referenced document is herein incorporated by reference in its entirety.

### TECHNICAL FIELD

The present disclosure relates generally to artificial intelligence systems and, more particularly, to multi-agent systems for enterprise workflows, including systems that generate, implement, execute, and evaluate agent-based workflows using large language models and other computational tools.

### BACKGROUND

Multi-agent systems (MAS) are increasingly used to automate complex workflows and decision-making processes in enterprise settings. In a typical MAS, multiple software agents cooperate to achieve an objective by dividing work into tasks such as information gathering, analysis, report generation, recommendation, and business process automation. For example, an enterprise may deploy an MAS in which one agent performs market research, another agent synthesizes a competitive landscape report, and a third agent produces actionable recommendations for product development or go-to-market planning. To coordinate such workflows, agents are commonly configured with role definitions and task assignments, and they may exchange intermediate results to complete a multi-step workflow.

In many MAS implementations, an agent's configuration may include descriptive elements intended to shape the agent's behavior and expertise. Such descriptive elements may include a narrative or contextual description identifying an expertise domain and behavioral context for the agent, and may further capture the agent's intended decision-making approach. In addition, MAS configurations often define how agents interact, including dependencies among tasks, delegation strategies, and sequencing or orchestration logic across multiple workflow steps. Multi-agent frameworks and orchestration tools have emerged to assist developers in defining these agent configurations and executing the resulting workflows, sometimes integrating external tools (e.g., search tools, web scraping tools, internal enterprise tools, or other software functions) to enable agents to gather information and take actions.

Despite increasing adoption, constructing and maintaining a high-performing MAS for a given enterprise objective remains challenging. A workflow that performs well for one domain or dataset may perform poorly when objectives change, when constraints change, or when new data sources become available. In practice, developers and operators often iteratively refine MAS configurations by manually adjusting agent roles, tasks, interaction logic, and dependencies, then re-running the workflow to observe whether outputs improve. This manual refinement approach can be time-consuming and error-prone, particularly when the workflow spans multiple agents, multiple external tools, and multiple stages of execution and evaluation. The complexity increases further when an MAS must be deployed across different industries or use cases, where the appropriate agent team composition, task decomposition, and inter-agent workflow may vary significantly.

Related technologies also include systems that use large language models to assist with drafting content, generating plans, or critiquing outputs. In some implementations, an LLM may be used to review results generated by one or more agents and provide feedback, such as identifying missing considerations, unclear reasoning, or inconsistent conclusions. In other implementations, evaluation may be performed using fixed metrics or human-authored criteria. However, in enterprise workflows, output quality is frequently multi-dimensional and context-dependent. Criteria such as relevance to objectives, clarity and actionability for stakeholders, completeness with respect to the task scope, consistency across iterations, and depth of analysis can vary by domain, organization, and operational constraints. Consequently, evaluating whether an MAS output is “good” often requires domain-sensitive criteria and structured feedback rather than a single numeric score.

Another related area is automated workflow generation and composition. Some systems can construct a pipeline or workflow using available tools given a user-provided idea or objective. For instance, a user may provide an objective and a set of available tools/functions, and an automation system may compose a workflow that calls those tools in a sequence intended to produce a desired result. These systems can reduce development time by assisting with implementation planning and tool selection. Nevertheless, enterprise deployment often raises additional needs beyond composing a single pipeline from an explicit idea. For many organizations, a key challenge is identifying commercially and technically viable use cases that are feasible given the available toolset and integration constraints, particularly where the toolset includes heterogeneous functions and services. The feasibility dimension can include technical constraints (capabilities of available tools, integration requirements, execution reliability) and commercial constraints (scalability, return-on-investment potential, and market demand). In practice, many concepts fail because feasibility checks occur late, after significant effort has been expended on implementation.

Accordingly, there is a continuing need for technology that improves the lifecycle of enterprise multi-agent workflows, including (i) generating candidate enterprise use cases that can be realized with available tools and functions, (ii) evaluating technical and commercial feasibility early, (iii) translating validated objectives into implementable agent-based workflows with appropriate agent configurations, and (iv) enabling systematic evaluation and iterative refinement of those workflows based on performance feedback. A related need is to reduce reliance on manual trial-and-error modification of agent roles, tasks, inter-agent dependencies, and delegation strategies, while supporting robust evaluation based on criteria that reflect the objectives and context of the workflow.

### SUMMARY OF THE INVENTION

In one exemplary embodiment, a computer-implemented method is described. The method comprises: receiving, using a refinement controller comprising a large language model (LLM), configuration data defining a plurality of artificial intelligence (AI) agents having predefined roles, goals, and workflows; executing, by the refinement controller, the plurality of AI agents to perform tasks based on the configuration data to generate an output; evaluating, by the refinement controller using the LLM, the output against evaluation criteria; generating, by the refinement controller, a hypothesis for modifying at least one of the roles, workflows, or inter-agent dependencies based on the evaluation; and implementing, by the refinement controller, a modified configuration of the plurality of AI agents according to the hypothesis to produce a modified output.

In another exemplary embodiment, a system is described. The system comprises: at least one processor; and a memory storing computer-executable instructions that, when executed by the at least one processor, cause the system to: receive, using a refinement controller comprising a large language model (LLM), configuration data defining a plurality of artificial intelligence (AI) agents having predefined roles, goals, and workflows; execute, by the refinement controller, the plurality of AI agents to perform tasks based on the configuration data to generate an output; evaluate, by the refinement controller using the LLM, the output against evaluation criteria; generate, by the refinement controller, a hypothesis for modifying at least one of the roles, workflows, or inter-agent dependencies based on the evaluation; and implement, by the refinement controller, a modified configuration of the plurality of AI agents according to the hypothesis to produce a modified output.

In yet another exemplary embodiment, a non-transitory computer-readable storage medium is described. The storage medium stores instructions which, when executed by at least one processor, cause the at least one processor to perform operations comprising: receiving, using a refinement controller comprising a large language model (LLM), configuration data defining a plurality of artificial intelligence (AI) agents having predefined roles, goals, and workflows; executing, by the refinement controller, the plurality of AI agents to perform tasks based on the configuration data to generate an output; evaluating, by the refinement controller using the LLM, the output against evaluation criteria; generating, by the refinement controller, a hypothesis for modifying at least one of the roles, workflows, or inter-agent dependencies based on the evaluation; and implementing, by the refinement controller, a modified configuration of the plurality of AI agents according to the hypothesis to produce a modified output.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates an exemplary network environment in which an autonomous meta-framework platform and a target multi-agent system operate in communication with external tools and services, according to certain embodiments.

FIG. 2 illustrates an exemplary system block diagram of an autonomous meta-framework platform coupled with a target multi-agent system for generation and iterative refinement of multi-agent system definitions, according to certain embodiments.

FIG. 3 illustrates an exemplary data structure diagram of a multi-agent system definition comprising a plurality of agent definition data structures including role, goal, backstory, task, and dependency parameters, according to certain embodiments.

FIG. 4 illustrates an exemplary initialization and criteria generation process for constructing or loading a multi-agent system definition and generating qualitative evaluation criteria using a large language model, according to certain embodiments.

FIG. 5 illustrates an exemplary iterative refinement loop for autonomous execution, evaluation, hypothesis generation, variant synthesis, comparison, and selection of a best-performing multi-agent system configuration, according to certain embodiments.

FIG. 6 illustrates an exemplary tools-driven enterprise use-case generation process in which available computational tools are analyzed to generate and validate candidate enterprise use-cases for multi-agent system synthesis, according to certain embodiments.

FIG. 7 illustrates an exemplary variant comparison and selection architecture in which multiple multi-agent system variants are evaluated, ranked, and stored as a best-known configuration with associated version history and documentation, according to certain embodiments.

FIG. 8 illustrates an exemplary computing device architecture configured to implement one or more components of the autonomous meta-framework platform and the target multi-agent system, according to certain embodiments.

FIG. 9 is a schematic representation of an encoder-decoder architecture.

FIG. 10 shows an overview of an attention mechanism added onto a Recurrent Neural Network (RNN) encoder-decoder architecture.

FIG. 11 is a schematic representation of the calculation of self-attention showing one attention head.

FIG. 12 is a depiction of several attention heads in a Transformer block.

FIG. 13 is an illustration that shows how one can use multiple workers to compute the multi-head attention in parallel, as the respective heads compute their outputs independently of one another.

FIG. 14 is a portrayal of one encoder layer of a Transformer network.

FIG. 15 shows a schematic overview of a Transformer model.

FIG. 16 is a depiction of a Vision Transformer (ViT).

FIG. 17 illustrates a processing flow of the Vision Transformer (ViT).

FIG. 18 shows example software code that implements a Transformer block.

FIG. 19 illustrates an example configuration of a computing device that can be used to implement the systems and techniques described herein.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

### Indicia of Novelty, Inventiveness, Non-Obviousness, and Subject-Matter Eligibility

Modern enterprise, scientific, defence, financial, and healthcare organizations increasingly deploy Multi-Agent Systems (MAS) to automate complex workflows and decision-making processes. These MAS comprise multiple Artificial Intelligence (AI) agents that interact and collaborate to achieve specific goals such as market research, report generation, product recommendation, and business process automation. Practitioners currently design MAS through manual specification of agent roles, goals, tasks, and inter-agent dependencies. This design process demands significant domain expertise, implementation time, and iterative trial and error refinement. Organizations expend substantial resources on MAS configuration that frequently produces suboptimal agent definitions because the refinement process requires continuous human intervention at every stage.

The fundamental limitation of existing MAS development approaches lies in their inability to autonomously generate and optimize agent configurations without human specification of application goals, agent designs, or success metrics. Current systems rely on manual definition of agent characteristics through explicit programming or configuration files. These systems cannot infer what multi-agent applications to build from available computational tools. They cannot synthesize complete agent personas that capture behavioral nuance and decision-making rationale. They cannot derive evaluation criteria from code analysis without human provided parameters. Most critically, they cannot perform hypothesis-driven optimization that proposes modifications with documented rationale for expected improvements. This disconnect between agent design and autonomous improvement creates a significant barrier to deploying MAS that can adapt their configurations to match evolving requirements.

Current approaches in the prior art include static agent frameworks that require complete manual specification of all agent parameters. Automated Machine Learning (AutoML) and Neural Architecture Search (NAS) systems optimize model hyperparameters but do not address the semantic aspects of agent persona definition. Evolutionary algorithms apply random mutations without rationale for why modifications should improve performance. Large Language Model (LLM) based agent systems generate outputs but lack systematic frameworks for iterative self-improvement. Workflow automation platforms coordinate task execution but do not autonomously refine agent definitions based on output quality. Reinforcement learning approaches require predefined reward functions that humans must specify rather than inferring from system objectives.

The technology disclosed addresses these limitations through an autonomous meta-framework that generates and optimizes MAS without requiring human specification of application goals, agent designs, or evaluation criteria. The system receives an input comprising at least one of three modes. The first mode accepts data identifying a set of available computational tools from which the system autonomously generates candidate enterprise use-cases. The second mode accepts an idea description defining objectives from which the system synthesizes agent definitions. The third mode accepts an existing multi-agent system implementation from which the system infers objectives through code analysis. This flexible input architecture enables the system to operate across diverse deployment scenarios while maintaining autonomous operation throughout the generation and optimization process.

The core technical contribution resides in the generation of agent definition data structures that include a backstory parameter expressed in natural language. The backstory parameter defines an expertise domain, a behavioral context, and a decision-making rationale for each corresponding agent. This backstory parameter influences runtime behavior of the corresponding agent by shaping how the agent interprets tasks, generates outputs, and interacts with other agents. Unlike prior art systems that define agents through simple role labels or task lists, the backstory parameter captures the semantic richness of agent expertise and behavioral nuance that determines effective agent performance. Each agent definition data structure further comprises a role parameter defining functions and responsibilities, a goal parameter specifying objectives, a task parameter specifying assigned operations and expected outputs, and dependency and delegation references defining inter-agent relationships and task delegation strategies.

The technology disclosed further addresses the critical limitation of requiring human-specified evaluation parameters. The system generates qualitative evaluation criteria by analyzing the multi-agent system definition using a Large Language Model (LLM). The system derives these qualitative evaluation criteria without requiring human-specified evaluation parameters. When the input comprises an existing multi-agent system implementation, the system analyzes source code or workflow logic to infer objectives and derives the qualitative evaluation criteria from the inferred objectives. The qualitative evaluation criteria comprise relevance, clarity, consistency, completeness, and depth of analysis. This autonomous criteria generation enables the system to evaluate agent outputs against meaningful quality dimensions without human intervention in defining success metrics.

The iterative optimization process employs a hypothesis-driven approach that fundamentally distinguishes the technology from random mutation or gradient-based refinement. The system iteratively optimizes the multi-agent system definition by generating hypothesis data comprising proposed modifications with rationale. The rationale identifies why each proposed modification is expected to yield improved performance relative to the qualitative evaluation criteria. The system synthesizes a plurality of variant multi-agent system definitions where each variant implements a different combination of the proposed modifications. The system evaluates the variants against the qualitative evaluation criteria, ranks them based on performance, and stores a reference multi-agent system definition corresponding to a top-performing variant for use in subsequent optimization iterations. This documented hypothesis approach creates an audit trail that explains the reasoning behind each modification and the expected improvements.

The system implements autonomous enterprise use-case generation when the input comprises data identifying available computational tools. The system analyzes capabilities of the available computational tools and autonomously generates candidate enterprise use-cases implementable using those tools. The system evaluates the candidate enterprise use-cases for technical feasibility based on constraints including availability of required computational tools, compatibility of tool integrations, and framework support. The system further evaluates commercial viability based on considerations including scalability, return on investment potential, and market demand. This autonomous ideation capability enables the system to discover valuable MAS applications that humans might not envision given the available tool set.

The technology disclosed operates through a specialized multi-agent architecture dedicated to the refinement process itself. A refinement agent delegates tasks to other agents for executing, evaluating, modifying, optimizing, and storing multi-agent configurations. A hypothesis agent proposes enhancements to agent definitions including roles, goals, backstories, and tasks based on performance analysis. A modification agent synthesizes new multi-agent system versions from top-performing variants using hypothesized changes to improve alignment with the qualitative evaluation criteria. An execution agent runs and debugs modified versions of the multi-agent system and generates outputs for comparison. An evaluation agent assesses outputs from multiple variants and identifies weaknesses and areas for improvement. A comparison agent compares outputs generated by modified systems against the configuration with improved performance and ranks the variants. A memory agent stores and retrieves top-performing variants and outputs in long-term memory for referencing in subsequent iterations. A documentation agent records all changes, decisions, and performance outcomes throughout the refinement process. This specialized agent architecture ensures systematic and traceable optimization.

The system operates autonomously without human intervention until a termination condition is satisfied. The termination condition comprises at least one of a predefined performance threshold being met, a maximum iteration count being reached, or performance improvement falling below a threshold across successive iterations. The system may also receive optional human input at predefined intervention points while operating fully autonomously in absence of such input. This design enables complete automation for resource-constrained deployments while preserving the option for human guidance when domain expertise is available.

The technology disclosed produces specific technical improvements to computer systems that extend beyond abstract ideas or conventional automation. The system transforms the abstract concept of agent optimization into a concrete technical implementation through specific data structures, processing modules, and algorithmic steps. The backstory parameter represents a novel data structure that captures semantic meaning in natural language and directly influences agent runtime behavior through specific technical mechanisms. The LLM-based criteria generation produces new qualitative evaluation parameters from code analysis rather than applying predetermined rules. The hypothesis-driven optimization generates documented proposals with technical rationale rather than random perturbations. These technical elements produce measurable improvements in agent system performance without requiring the human expertise and time investment that prior art systems demand.

The integration of autonomous use-case generation, backstory-based agent synthesis, LLM-inferred evaluation criteria, and hypothesis-driven optimization represents a technical architecture that provides unconventional technical solutions to problems specifically arising in MAS development. The system does not merely automate manual steps but introduces new technical capabilities that were previously impossible. No human could manually analyze all possible combinations of available tools to identify optimal enterprise use-cases. No existing system could infer meaningful evaluation criteria from code without explicit human guidance. No prior approach could generate modification hypotheses with documented rationale for expected improvements at the scale and speed the technology enables.

The technology disclosed therefore represents subject matter that provides specific technical improvements to computer systems for autonomous multi-agent system generation and optimization through backstory-based agent definition, LLM-inferred evaluation criteria, and hypothesis-driven iterative refinement with documented rationale.

### Autonomous Meta-Framework System

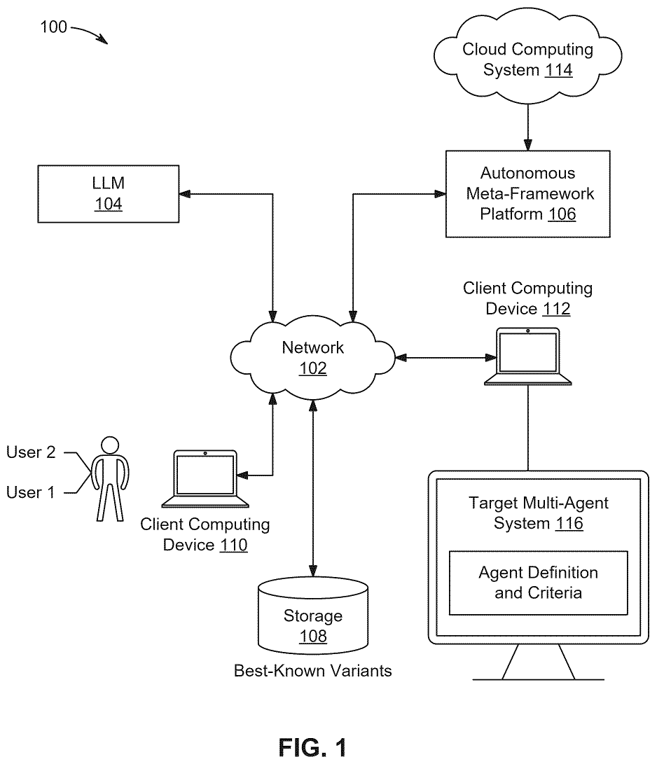

FIG. 1 illustrates an autonomous meta-framework system 100 for generation and optimization of multi-agent systems. The autonomous meta-framework system 100, also referred to as the system 100, is configured to autonomously generate, implement, and execute multi-agent applications for various enterprise use-cases. The system 100 implements a multi-agent architecture for continuous refinement and optimization of multi-agent systems by iteratively and autonomously evaluating, modifying, and executing agent-based workflows. A multi-agent system (MAS) comprises several artificial intelligence (AI) agents that perform specific tasks based on predefined roles, goals, and tasks. Each agent has a unique backstory that defines the expertise and purpose of the agent within the workflow. The agents are designed to work cooperatively to achieve complex objectives, including market research, report generation, product recommendation, and business process automation. The system 100 utilizes generated and optionally revised qualitative criteria for evaluating the output of multi-agent systems and generates modifications to agent roles, goals, tasks, and workflows. The system 100 can be implemented in various enterprise applications, including autonomous use-case generation, end-to-end implementation of multi-agent frameworks, execution and testing of implementations, and optimization of agent-based workflows across industries.

The system 100 comprises a network 102 configured to facilitate communication among a plurality of components. The network 102 may be implemented using wired and wireless network infrastructures, wherein the network 102 supports multiple network protocols including Transfer Control Protocol/Internet Protocol (TCP/IP), Hypertext Transfer Protocol (HTTP), Secure Shell (SSH), and WebRTC. The network 102 is further operable to establish wireless network connections through communication standards including Wi-Fi (IEEE 802.11), Bluetooth, ZigBee, and satellite communications. In certain embodiments, the network 102 supports wired connections, including Ethernet, fiber-optic interfaces, digital subscriber line (DSL), and coaxial cable networks.

The system 100 further comprises a large language model 104 operably connected to the network 102. The large language model 104, also referred to as an LLM 104, is configured to assess outputs from various iterations of multi-agent system configurations, facilitating continuous improvement through iterative testing and optimization. The large language model 104 is employed to generate qualitative and quantitative evaluation criteria, including relevance, clarity, depth of analysis, actionability, and consistency, to evaluate agent outputs and guide the refinement process. The large language model 104 is further configured to analyze outputs from multiple variants, identifying weaknesses and areas for improvement. The large language model 104 may be implemented as a cloud-based service accessible through the network 102 or as a locally deployed model within the autonomous meta-framework platform 106.

The system 100 further comprises an autonomous meta-framework platform 106 operably connected to the network 102. The autonomous meta-framework platform 106 is configured to autonomously generate multi-agent application ideas across industries, develop feasible implementations, and perform end-to-end execution without human intervention. The autonomous meta-framework platform 106 leverages capabilities of the large language model 104 to create, implement, and execute complex projects without human-in-the-loop interaction. The autonomous meta-framework platform 106 is implemented as a multi-agent system composed of agents who develop enterprise use-case ideas that can be realized with given tools and then evaluate commercial and technical feasibility of the enterprise use-case ideas. The autonomous meta-framework platform 106 comprises a plurality of specialized agents configured to perform specific functions within the refinement and optimization process as part of a synthesis framework and an evaluation framework.

The autonomous meta-framework platform 106 comprises a refinement agent configured to serve as the central agent responsible for delegating tasks to other agents in executing, evaluating, modifying, optimizing, and storing multi-agent configurations. The refinement agent autonomously identifies areas of improvement by analyzing previous outputs based on qualitative and quantitative criteria generated by the large language model 104, and generates specific hypotheses for optimizing agent roles, workflows, and dependencies. The refinement agent manages the iterative process by coordinating hypothesis generation, implementation of changes, and ranking of top-performing variants.

The autonomous meta-framework platform 106 further comprises an execution agent configured to run and debug modified versions of multi-agent systems, and generate new outputs for comparison. The execution agent is responsible for running code, debugging, gathering outputs, and facilitating successful completion of tasks for each variant of the multi-agent system. The execution agent validates, executes, and attempts to debug multiple variants to collect outputs and quantitative metrics from each variant.

The autonomous meta-framework platform 106 further comprises an evaluation agent configured to utilize the large language model 104 to assess the quality and effectiveness of outputs from each execution regarding predefined or generated qualitative criteria. The evaluation agent generates feedback on the strengths and weaknesses of each multi-agent version's performance. The evaluation agent employs the large language model 104 to assess outputs from multiple variants, identifying weaknesses and areas for improvement.

The autonomous meta-framework platform 106 further comprises a hypothesis agent configured to propose enhancements to top-performing agent definitions, including roles, goals, backstories, and tasks, as well as interactions and workflows based on performance analysis. The hypothesis agent analyzes qualitative and quantitative performance of the current multi-agent system in producing output and identifies areas for improvement. The hypothesis agent generates specific hypotheses for modifying agent roles, workflows, and dependencies to address identified areas for improvement. The hypotheses generated by the hypothesis agent are based on evaluation reports from the evaluation agent.

The autonomous meta-framework platform 106 further comprises a modification agent configured to synthesize new multi-agent system versions from top-performing variants using hypothesized changes to improve alignment with qualitative criteria. The modification agent implements hypothesized changes by integrating modifications to create multiple versions of the agent system. The modification agent generates new variants of the multi-agent system by altering agent logic and workflow, including agents, roles, tasks, and interactions. The modification agent documents reasoning behind each modification and expected improvements.

The system 100 further comprises a storage 108 operably connected to the network 102. The storage 108 is configured to store and retrieve best-performing variants and outputs of the best-performing variants in a long-term memory for referencing the best-performing variants in future iterations. The storage 108 may be implemented as a standalone data storage unit or an integrated component within a distributed storage system. In certain embodiments, the storage 108 includes onboard storage media, database management systems, and real-time data retrieval capabilities. The storage 108 may store multi-agent system configurations in raw format for detailed post-processing or in processed format with preliminary enhancements for real-time analysis. The storage 108 is configured to maintain a version history of agent definition data structures across optimization iterations.

The system 100 further comprises a client computing device 110 operably connected to the network 102. The client computing device 110 is configured to provide an interface for a first user (User 1) and a second user (User 2) designated as reference numeral 120 to interact with the autonomous meta-framework platform 106. The client computing device 110 may be implemented as a personal computer, laptop, tablet, smartphone, or any computing device capable of establishing network connectivity. The client computing device 110 includes a communications unit, electrical circuitry, and a memory having program instructions executable by at least one processor. The communications unit of the client computing device 110 facilitates data exchange between the client computing device 110 and the autonomous meta-framework platform 106, enabling real-time data transmission and remote processing.

The system 100 further comprises a client computing device 112 operably connected to the network 102. The client computing device 112 is configured to host and execute a target multi-agent system 116. The client computing device 112 may be implemented using a plurality of computing architectures, including, but not limited to, desktop computers, server systems, and virtual machines. The client computing device 112 includes one or more processors configured to control operations and functionality of the target multi-agent system 116, as well as to facilitate communications between various components. The one or more processors may include any suitable processing circuitry, including a central processing unit (CPU), graphics processing unit (GPU), microprocessor, digital signal processor (DSP), or any combination thereof. In certain embodiments, the client computing device 112 utilizes hardware logic components including field-programmable gate arrays (FPGAs), application-specific integrated circuits (ASICs), application-specific standard products (ASSPs), system-on-chip (SoC) architectures, and complex programmable logic devices (CPLDs), which enable high-speed parallel processing of multi-agent system operations.

The system 100 further comprises a cloud computing system 114 operably connected to the network 102. The cloud computing system 114 is configured to provide scalable computing resources for the autonomous meta-framework platform 106 and the large language model 104. The cloud computing system 114 may be implemented using distributed computing architectures, wherein computational tasks are partitioned and executed across multiple networked computing nodes, enhancing processing capacity and accessibility. The cloud computing system 114 is operable to communicate with additional devices, servers, and systems, including information systems, remote control devices, and resource management equipment. The cloud computing system 114 is configured to transmit and receive data over wired and wireless networks, wherein a communications interface of the cloud computing system 114 supports multiple network protocols.

The system 100 further comprises a target multi-agent system 116 hosted on the client computing device 112. The target multi-agent system 116 comprises agent definition data structures and qualitative criteria. Each agent definition data structure comprises a role parameter, a goal parameter, a backstory parameter expressed in natural language, a task parameter, and dependency and delegation references. The role parameter defines the function and responsibilities of the agent within the multi-agent system. The goal parameter specifies the objectives that the agent is designed to achieve. The backstory parameter defines the expertise and purpose of the agent within the workflow, expressed in natural language. The task parameter specifies assigned operations and expected outputs for the agent. The dependency and delegation references define inter-agent relationships and task delegation strategies.

The autonomous meta-framework platform 106 is configured to refine given multi-agent system implementations by autonomously synthesizing changes to agent definitions, including agent roles, goals, backstories, tasks, delegation strategies, and dependencies. In cases where no initial implementation is provided, the autonomous meta-framework platform 106 generates an initial multi-agent system based on an input description, synthesizing an initial agentic system that aligns with provided objectives. The autonomous meta-framework platform 106 continuously compares outputs of different configurations using the large language model 104, and stores top-performing variants in the storage 108, allowing for ongoing optimization without human intervention.

The autonomous meta-framework platform 106 leverages generated qualitative criteria inferred from code analysis and optionally revised qualitative criteria to evaluate outputs, generate improvement hypotheses, modify agent roles and workflows, and test new configurations. The qualitative criteria comprise relevance, clarity, consistency, completeness, and depth of analysis. Relevance assesses whether outputs align with objectives identified from the code and whether outputs are pertinent to intended tasks and goals assigned to agents. Clarity evaluates how well output is presented and structured, and whether output is understandable and actionable for stakeholders. Consistency analyzes consistency of outputs across iterations and whether outputs reflect a stable understanding of objectives and tasks over time. Completeness checks whether outputs cover all aspects of tasks or goals specified in agent definitions and whether any critical areas or components are overlooked. Depth of analysis evaluates whether output provides comprehensive analysis with insights beyond surface-level data and whether output leads to actionable recommendations.

In addition to qualitative criteria, the autonomous meta-framework platform 106 utilizes specific quantitative metrics to complement evaluation. The quantitative metrics comprise execution time, success rate, and benchmarking. Execution time measures time taken by the multi-agent system to produce outputs, assessing efficiency and responsiveness. Success rate quantifies the proportion of tasks completed by the multi-agent system relative to total tasks assigned, reflecting overall effectiveness. Benchmarking evaluates outputs of the multi-agent system regarding assigned tasks on a dataset with ground-truths and a benchmarking metric.

The system 100 enables continuous refinement and optimization of a multi-agent framework by generating hypotheses for improvement, modifying the multi-agent system, and iteratively comparing outputs to find a configuration with improved performance to be used as a basis for successive iterations. The system 100 operates by continuously running a cycle of execution, evaluation, hypothesis generation, modification, and comparison. Each iteration results in a refined version of the multi-agent system. The process is entirely autonomous and can run indefinitely, refining the multi-agent system based on new inputs, goals, or changing qualitative and quantitative benchmarks.

The synthesis framework of the autonomous meta-framework platform 106 is a core component configured for hypothesizing and implementing changes to agent definitions based on performance metrics and contextual feedback. The evaluation framework of the autonomous meta-framework platform 106 utilizes the large language model 104 to score and compare outputs of different agent configurations against predefined qualitative performance criteria.

The system 100 provides autonomous improvement wherein the system 100 does not require human intervention to improve and optimize multi-agent systems. The system 100 continuously evaluates and modifies multi-agent configurations based on output quality. The system 100 provides efficiency by automating refinement of agent systems, reducing time and cost associated with manual optimization. The system 100 provides scalability wherein the system 100 can scale across multiple domains and industries by adjusting agent logic to suit different goals or markets.

### System for Autonomous Generation and Optimization of Multi-Agent Systems

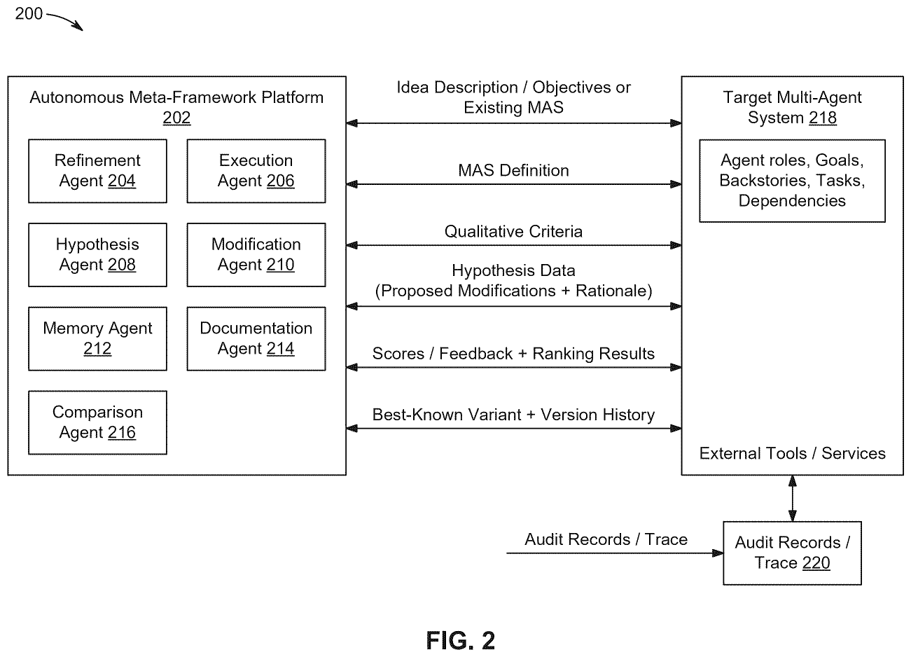

FIG. 2 illustrates a system environment 200 for an autonomous generation and optimization of a target multi-agent system. The system environment 200 represents an operational arrangement in which a multi-agent architecture is configured to receive an idea description defining objectives or an existing multi-agent system implementation, generate a multi-agent system definition, execute a target multi-agent system, and iteratively refine the multi-agent system definition using qualitative evaluation criteria derived through a large language model. The system environment 200 is suitable for enterprise workflows in which complex objectives are addressed through coordinated execution of multiple agents and iterative evaluation of outputs.

As shown in FIG. 2, the system environment 200 includes an autonomous meta-framework platform 202 and a target multi-agent system 218 that are communicatively coupled to exchange data associated with generation, execution, evaluation, and refinement. The target multi-agent system 218 represents an executable multi-agent implementation that includes agent roles, goals, backstories, tasks, and dependencies. The target multi-agent system 218 may further interact with external tools/services, which may include, but are not limited to, software tools, application programming interfaces, services, or other computational resources used by agents to perform assigned tasks and generate outputs.

The autonomous meta-framework platform 202 includes a refinement agent 204, an execution agent 206, a hypothesis agent 208, a modification agent 210, a memory agent 212, a documentation agent 214, and a comparison agent 216. Together, these agents enable the autonomous meta-framework platform 202 to manage generation, execution, evaluation, and iterative modification of the target multi-agent system 218 through structured data exchange and repeated processing cycles.

In operation, the autonomous meta-framework platform 202 receives, as an input, an idea description defining objectives for a target multi-agent system or an existing mas implementation. The existing mas implementation may include source code or workflow logic that describes how agents interact and perform tasks. In some embodiments, the input further includes data identifying a set of available computational tools. In such embodiments, the autonomous meta-framework platform 202 analyzes capabilities of the available computational tools and generates candidate enterprise use-cases that are implementable using the available computational tools. The candidate enterprise use-cases are evaluated for technical feasibility and commercial viability, and a validated candidate enterprise use-case is used as the idea description for subsequent processing.

Based on the received input, the autonomous meta-framework platform 202 generates a multi-agent system definition. The multi-agent system definition comprises a plurality of agent definition data structures. Each agent definition data structure includes a backstory parameter expressed in natural language that defines an expertise domain, a behavioral context, and a decision-making rationale for a corresponding agent. In addition, each agent definition data structure may include, but is not limited to, a role parameter defining an agent function, a goal parameter defining success criteria, and a task parameter defining assigned operations and expected outputs. The multi-agent system definition further includes inter-agent dependencies and delegation strategies that specify relationships and coordination among agents. The multi-agent system definition is communicated to the target multi-agent system 218 for execution.

The autonomous meta-framework platform 202 generates qualitative evaluation criteria by analyzing the multi-agent system definition using a large language model. The qualitative evaluation criteria are derived without requiring human-specified evaluation parameters. In embodiments where the input includes an existing mas implementation, the qualitative evaluation criteria are generated by analyzing source code or workflow logic to infer objectives and deriving the qualitative evaluation criteria from the inferred objectives. The qualitative evaluation criteria may include, but are not limited to, relevance, clarity, consistency, completeness, and depth of analysis, and are used to assess outputs generated by the target multi-agent system 218.

The execution agent 206 executes the target multi-agent system 218 in accordance with the multi-agent system definition and produces outputs associated with the enterprise use-case. The outputs are evaluated using the qualitative evaluation criteria to generate scores, feedback, and ranking results. The scores, feedback, and ranking results characterize performance of the outputs relative to the qualitative evaluation criteria and provide input for subsequent refinement.

Based on the evaluation results, the hypothesis agent 208 generates hypothesis data comprising proposed modifications with rationale. The hypothesis data identifies modifications that are expected to yield improved performance relative to the qualitative evaluation criteria. The proposed modifications may target, but are not limited to, the backstory parameter, agent roles, agent goals, agent tasks, and inter-agent dependencies. The modification agent 210 applies the hypothesis data to the multi-agent system definition to synthesize a plurality of variant multi-agent system definitions, each variant implementing a different combination of proposed modifications.

The execution agent 206 executes the target multi-agent system 218 using the variant multi-agent system definitions, and the resulting outputs are evaluated using the qualitative evaluation criteria. The comparison agent 216 compares the evaluation results associated with the variants to identify a best-known variant. The memory agent 212 stores the best-known variant and maintains a version history of multi-agent system definitions across optimization iterations. The stored version history provides a reference for subsequent iterations and enables tracking of changes over time.

The documentation agent 214 generates audit records/trace 220 that document hypothesis data tested, modifications applied, evaluation outcomes, comparison results, and selection decisions with supporting rationale. The audit records/trace 220 provide a structured record of the refinement process and support analysis, review, and reuse of information associated with the autonomous generation and optimization of the target multi-agent system 218.

The refinement agent 204 supports continued operation of the system environment 200 over successive cycles until a termination condition is satisfied. The termination condition may include, but is not limited to, a predefined performance threshold being met, a maximum iteration count being reached, or performance improvement falling below a threshold across successive iterations.

### Workflow for Autonomous Generation and Optimization of Multi-Agent Systems

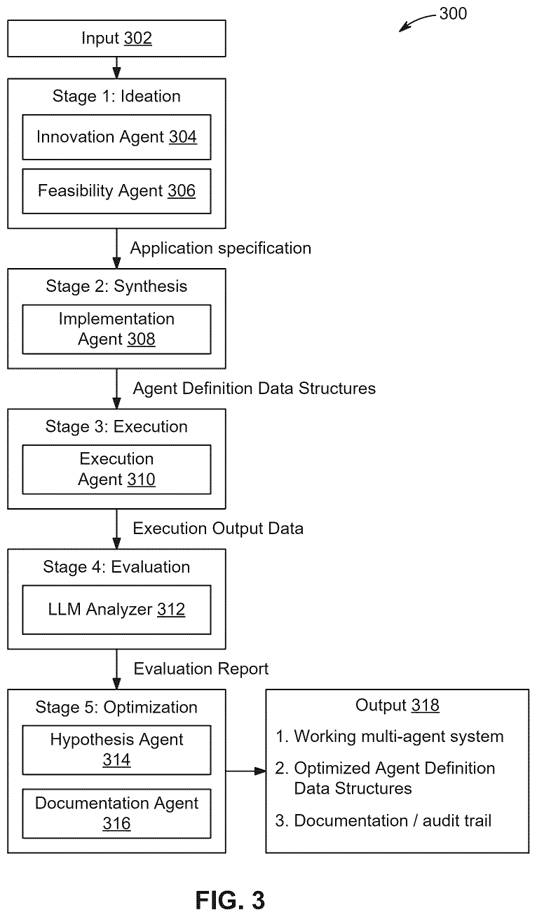

FIG. 3 illustrates a workflow 300 for autonomous generation and optimization of multi-agent systems. The workflow 300, also referred to as the process, is configured to autonomously generate enterprise use-case ideas, implement multi-agent systems, execute and test implementations, and optimize agent-based workflows through iterative refinement. The workflow 300 implements a stage-based architecture comprising an ideation stage, a synthesis stage, an execution stage, an evaluation stage, and an optimization stage. Each stage of the workflow 300 is performed by one or more specialized agents configured to accomplish specific objectives within an autonomous meta-framework platform. The workflow 300 operates by continuously running a cycle of execution, evaluation, hypothesis generation, modification, and comparison. Each iteration of the workflow 300 results in a refined version of a multi-agent system. The workflow 300 is entirely autonomous and can run indefinitely, refining the multi-agent system based on new inputs, goals, or changing qualitative and quantitative benchmarks. The workflow 300 can be implemented in various enterprise applications, including market research, business process automation, product development, report generation, product recommendation, and strategic decision-making across industries.

The workflow 300 commences with receiving an input 302. The input 302 is received by the autonomous meta-framework platform. The input 302 comprises at least one of data identifying a set of available computational tools, an idea description defining objectives, or an existing multi-agent system implementation. When the input 302 comprises data identifying the set of available computational tools, the workflow 300 proceeds to generate candidate enterprise use-cases implementable using the available computational tools. When the input 302 comprises the idea description defining objectives, the workflow 300 proceeds to synthesize agent definition data structures based on objectives defined in the idea description. When the input 302 comprises the existing multi-agent system implementation, the workflow 300 proceeds to analyze source code or workflow logic of the existing multi-agent system implementation to infer objectives and generate qualitative evaluation criteria from the inferred objectives. The input 302 may further comprise qualitative criteria for output evaluation, wherein the qualitative criteria may be provided with the idea description or inferred from the existing multi-agent system implementation by a large language model.

The workflow 300 comprises a stage 1: ideation configured to generate and validate enterprise use-case ideas for multi-agent system applications. The stage 1: ideation is configured to identify potential areas for multi-agent system applications that can be implemented using available tools provided in the input 302. The stage 1: ideation comprises an innovation agent 304 and a feasibility agent 306 working cooperatively to identify and assess candidate enterprise use-cases.

The innovation agent 304 is configured to generate disruptive business models by tracking emerging trends and technologies. The innovation agent 304 identifies potential areas for multi-agent system applications that can be implemented using available tools. The innovation agent 304 has a role of generating disruptive business models by tracking emerging trends and technologies and identifying potential areas for multi-agent system applications that can be implemented using available tools. The innovation agent 304 has a goal of identifying new areas for multi-agent system applications across industries, wherein ideas generated by the innovation agent 304 can be realized with tools and functions available within the framework. The innovation agent 304 has a backstory defining the innovation agent 304 as a pioneer in innovation with deep expertise in identifying market shifts and technological disruptions, capable of ideating impactful business models that are forward-looking and disruptive.

The feasibility agent 306 is configured to evaluate technical and commercial feasibility of ideas generated by the innovation agent 304. The feasibility agent 306 determines whether candidate enterprise use-cases can be practically implemented with available tools and are viable in the current market. The feasibility agent 306 has a role of evaluating the technical and commercial feasibility of ideas generated by the innovation agent 304, wherein the feasibility agent 306 verifies that candidate enterprise use-cases can be practically implemented with available tools and are viable in the current market. The feasibility agent 306 has a goal of assessing each generated idea based on technical constraints, including available tools, integrations, and frameworks, and commercial considerations, including scalability, return on investment (ROI) potential, and market demand. The feasibility agent 306 provides feedback to the innovation agent 304 to refine ideas iteratively. The feasibility agent 306 has a backstory defining the feasibility agent 306 as having evolved from early attempts to integrate project management and technical validation, driven by the realization that many great ideas failed due to a lack of feasibility checks at an early stage, wherein the feasibility agent 306 verifies that only implementable and commercially sound ideas proceed to the next phase.

The stage 1: ideation produces an application specification as output. The application specification comprises a validated candidate enterprise use-case that has been assessed for technical feasibility and commercial viability by the feasibility agent 306. The application specification defines objectives for a target multi-agent system to be synthesized in subsequent stages of the workflow 300.

The workflow 300 further comprises a stage 2: synthesis configured to convert the validated candidate enterprise use-case into an operational multi-agent system. The stage 2: synthesis comprises an implementation agent 308 configured to construct a working prototype of the multi-agent system.

The implementation agent 308 is configured to convert the validated use-case from the stage 1: ideation into an operational multi-agent system by selecting appropriate tools and frameworks for seamless integration. The implementation agent 308 has a role of converting the validated use-case into an operational multi-agent system, selecting appropriate tools, including but not limited to SerperDevTool and ScrapeWebsiteTool, and frameworks for seamless integration. The implementation agent 308 has a goal of autonomously configuring tools and frameworks to implement each use-case effectively, wherein the multi-agent system functions as intended. The implementation agent 308 has a backstory defining the implementation agent 308 as a highly skilled developer who is an expert in orchestrating complex multi-agent systems, with a deep understanding of the technical landscape, wherein the implementation agent 308 verifies that the multi-agent system is efficient and scalable.

The implementation agent 308 defines roles, goals, backstories, and tasks of agents involved in the target multi-agent system and develops the agents using a multi-agent framework. The implementation agent 308 synthesizes agent definition data structures for the target multi-agent system, wherein each agent definition data structure comprises a role parameter, a goal parameter, a backstory parameter expressed in natural language, a task parameter, and dependency and delegation references. The multi-agent system is then built and tested by the implementation agent 308 to verify seamless functionality.

The stage 2: synthesis produces agent definition data structures as output. The agent definition data structures comprise a plurality of agent definitions, wherein each agent definition specifies roles, goals, backstories, tasks, delegation strategies, and dependencies for a corresponding agent in the target multi-agent system.

The workflow 300 further comprises a stage 3: execution configured to run and test the multi-agent system synthesized in the stage 2: synthesis. The stage 3: execution comprises an execution agent 310 configured to execute the implemented use-case and continuously monitor performance of the multi-agent system in real-time.

The execution agent 310 is configured to adjust parameters as necessary to optimize outcomes during execution. The execution agent 310 has a role of executing the implemented use-case and continuously monitoring performance of the multi-agent system in real-time, adjusting parameters as necessary to optimize outcomes. The execution agent 310 has a goal of verifying successful execution of the multi-agent system, tracking performance outcomes, and optimizing processes based on simulated data and results. The execution agent 310 is responsible for running code, debugging, gathering outputs, and verifying successful completion of tasks for each variant of the multi-agent system. The execution agent 310 validates, executes, and attempts to debug multiple variants to collect outputs and quantitative metrics from each variant. In certain embodiments, the execution agent 310 creates mockup data or simulates human-in-the-loop inputs to facilitate accurate testing. Feedback from the stage 3: execution is returned to relevant agents to refine and improve the multi-agent system.

The stage 3: execution produces execution output data as output. The execution output data comprises results generated by the target multi-agent system during execution, including task completion status, performance metrics, and any errors or exceptions encountered during execution.

The workflow 300 further comprises a stage 4: evaluation configured to assess quality and effectiveness of outputs generated during the stage 3: execution. The stage 4: evaluation comprises an LLM analyzer 312 configured to utilize a large language model to assess outputs from multiple variants of the multi-agent system. The LLM analyzer 312 is also referred to as an evaluation agent.

The LLM analyzer 312 identifies weaknesses and areas for improvement in the execution output data. The LLM analyzer 312 generates feedback on strengths and weaknesses of each multi-agent version's performance. The LLM analyzer 312 employs the large language model to assess quality and effectiveness from each execution regarding qualitative evaluation criteria. The qualitative evaluation criteria comprise relevance, clarity, consistency, completeness, and depth of analysis. Relevance assesses whether outputs align with objectives identified from code analysis and whether outputs are pertinent to intended tasks and goals assigned to agents. Clarity evaluates how well output is presented and structured, and whether output is understandable and actionable for stakeholders. Consistency analyzes consistency of outputs across iterations and whether outputs reflect a stable understanding of objectives and tasks over time. Completeness checks whether outputs cover all aspects of tasks or goals specified in agent definitions and whether any critical areas or components are overlooked. Depth of analysis evaluates whether output provides comprehensive analysis with insights beyond surface-level data and whether output leads to actionable recommendations.

In addition to qualitative evaluation criteria, the LLM analyzer 312 utilizes specific quantitative metrics to complement evaluation. The quantitative metrics comprise execution time, success rate, and benchmarking. Execution time measures time taken by the multi-agent system to produce outputs, assessing efficiency and responsiveness. Success rate quantifies the proportion of tasks completed by the multi-agent system relative to total tasks assigned, reflecting overall effectiveness. Benchmarking evaluates outputs of the multi-agent system regarding assigned tasks on a dataset with ground-truths and a benchmarking metric.

The stage 4: evaluation produces an evaluation report as output. The evaluation report comprises feedback on areas where each multi-agent system's output can be optimized, including identified weaknesses, performance scores against qualitative evaluation criteria, and recommendations for improvement.

The workflow 300 further comprises a stage 5: optimization configured to generate hypotheses for improvement, modify the multi-agent system, and document the optimization process. The stage 5: optimization comprises a hypothesis agent 314 and a documentation agent 316 working cooperatively to refine the multi-agent system based on the evaluation report.

The hypothesis agent 314 is configured to propose enhancements to top-performing agent definitions, including roles, goals, backstories, and tasks, as well as interactions and workflows based on performance analysis. The hypothesis agent 314 analyzes qualitative and quantitative performance of the current multi-agent system in producing output and identifies areas for improvement. The hypothesis agent 314 generates specific hypotheses for modifying agent roles, workflows, and dependencies to address identified areas for improvement, emphasizing efficiency and alignment with defined criteria. The hypotheses generated by the hypothesis agent 314 are based on the evaluation report from the stage 4: evaluation. The hypothesis agent 314 generates hypothesis data comprising proposed modifications to agent definition data structures and rationale indicating why each proposed modification is expected to yield improved performance relative to the qualitative evaluation criteria.

The documentation agent 316 is configured to record all changes, decisions, and performance outcomes throughout the refinement process. The documentation agent 316 logs each workflow step, including hypotheses, modifications, evaluations, comparisons, and decisions with rationale for each decision. The documentation agent 316 compiles the iterative process, detailing changes, outcomes, and insights gained during optimization. The documentation agent 316 provides a clear record of modifications, rationale for the modifications, and resulting improvements. The documentation agent 316 prepares comprehensive documentation for future reference, enabling a clear understanding of the optimization journey and impact of the optimization journey.

The stage 5: optimization produces an output 318. The output 318 comprises three components. A first component of the output 318 comprises a working multi-agent system. The working multi-agent system represents a configuration with improved performance relative to an initial multi-agent system synthesized in the stage 2: synthesis. A second component of the output 318 comprises optimized agent definition data structures. The optimized agent definition data structures comprise refined agent definitions with enhanced roles, goals, backstories, tasks, delegation strategies, and dependencies that have been optimized through iterative testing and modification. A third component of the output 318 comprises documentation and audit trail. The documentation and audit trail comprises comprehensive records of the optimization process, including hypotheses generated, modifications implemented, evaluation results, comparison outcomes, and decisions made with rationale throughout the workflow 300.

The workflow 300 continues until optimal configurations are identified, enhancing overall system performance. The workflow 300 provides autonomous improvement wherein the workflow 300 does not require human intervention to improve and optimize multi-agent systems. The workflow 300 continuously evaluates and modifies multi-agent configurations based on output quality. The workflow 300 provides efficiency by automating refinement of agent systems, reducing time and cost associated with manual optimization. The workflow 300 provides scalability wherein the workflow 300 can scale across multiple domains and industries by adjusting agent logic to suit different goals or markets. The workflow 300 provides a robust framework for continuous improvement, enabling the multi-agent system to adapt and respond to changing requirements effectively. The workflow 300 provides thorough documentation outlining the iterative refinement process, providing valuable insights for future developments and applications in AI-driven workflows.

### Agent Definition Data Structure Architecture

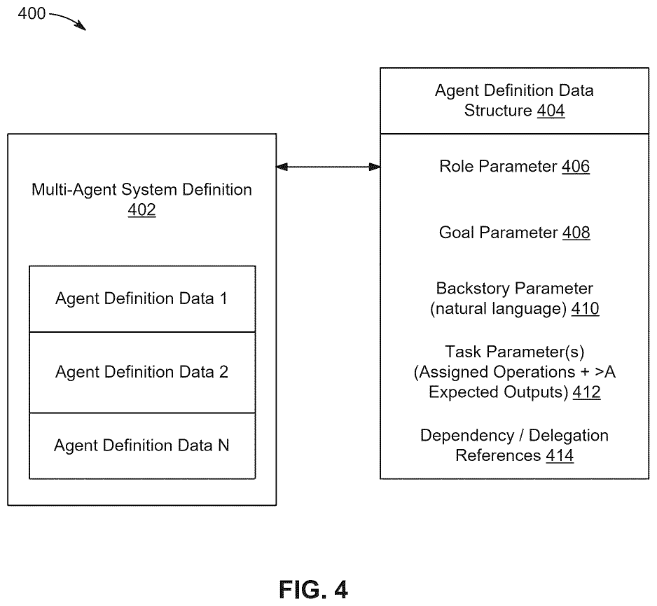

FIG. 4 illustrates an agent definition data structure architecture 400 for multi-agent systems. The agent definition data structure architecture 400, also referred to as the architecture 400, is configured to define the structure and composition of agent definitions within a multi-agent system. The architecture 400 implements a hierarchical data organization wherein a multi-agent system definition comprises a plurality of agent definition data structures, and each agent definition data structure comprises a plurality of parameters defining characteristics and behaviors of a corresponding agent. The architecture 400 can be implemented in various multi-agent system applications, including market research, report generation, product recommendation, business process automation, and enterprise use-case implementation across industries.

The architecture 400 comprises a multi-agent system definition 402. The multi-agent system definition 402 is configured to define an overall structure and composition of a multi-agent system. The multi-agent system definition 402 comprises a plurality of agent definition data, including agent definition data 1, agent definition data 2, and agent definition data N, wherein N represents any positive integer indicating a total number of agents in the multi-agent system. Each agent definition data within the multi-agent system definition 402 corresponds to a single agent within the multi-agent system. The multi-agent system definition 402 may be synthesized based on an idea description defining objectives, generated from analysis of available computational tools, or derived from an existing multi-agent system implementation. In cases where no initial implementation is provided, the multi-agent system definition 402 is generated based on an input description, synthesizing an initial agentic system that aligns with provided objectives.

The architecture 400 further comprises an agent definition data structure 404. The agent definition data structure 404 is configured to define characteristics, behaviors, and relationships of a single agent within the multi-agent system. Each agent definition data within the multi-agent system definition 402, including agent definition data 1, agent definition data 2, and agent definition data N, conforms to the agent definition data structure 404. The agent definition data structure 404 comprises a plurality of parameters, including a role parameter 406, a goal parameter 408, a backstory parameter 410, a task parameter 412, and dependency and delegation references 414.

The architecture 400 further comprises a role parameter 406 within the agent definition data structure 404. The role parameter 406 is configured to define the function and responsibilities of the corresponding agent within the multi-agent system. The role parameter 406 specifies a designated function that the agent performs within an agent-based workflow. The role parameter 406 may define roles including, but not limited to, an innovation agent role configured to generate disruptive business models by tracking emerging trends and technologies, a feasibility agent role configured to evaluate technical and commercial feasibility of generated ideas, an implementation agent role configured to convert validated use-cases into operational multi-agent systems, an execution agent role configured to execute implemented use-cases and monitor performance in real-time, an evaluation agent role configured to assess quality and effectiveness of outputs, a hypothesis agent role configured to propose enhancements to agent definitions based on performance analysis, a modification agent role configured to synthesize new multi-agent system versions from hypothesized changes, a comparison agent role configured to compare outputs generated by modified systems against a configuration with improved performance, a memory agent role configured to store and retrieve configurations with improved performance and outputs, and a documentation agent role configured to record all changes, decisions, and performance outcomes.

The architecture 400 further comprises a goal parameter 408 within the agent definition data structure 404. The goal parameter 408 is configured to specify objectives that the corresponding agent is designed to achieve within the multi-agent system. The goal parameter 408 defines target outcomes and success criteria for the agent. The goal parameter 408 may specify goals including, but not limited to, identifying new areas for multi-agent system applications across industries, assessing generated ideas based on technical constraints and commercial considerations, autonomously configuring tools and frameworks to implement use-cases effectively, verifying successful execution of the multi-agent system and tracking performance outcomes, assessing quality and effectiveness of outputs regarding qualitative evaluation criteria, and proposing specific enhancements to agent roles, workflows, and dependencies.

The architecture 400 further comprises a backstory parameter 410 within the agent definition data structure 404. The backstory parameter 410 is configured to define expertise and purpose of the corresponding agent within the workflow. The backstory parameter 410 is expressed in natural language. The backstory parameter 410 provides contextual information that shapes how the agent interprets tasks and interacts with other agents within the multi-agent system. The backstory parameter 410 defines a unique backstory for each agent that characterizes the expertise and purpose of the agent within the workflow. The backstory parameter 410 may define backstories including, but not limited to, a pioneer in innovation with deep expertise in identifying market shifts and technological disruptions, a validator evolved from early attempts to integrate project management and technical validation, and a highly skilled developer who is an expert in orchestrating complex multi-agent systems with deep understanding of the technical landscape.

The architecture 400 further comprises a task parameter 412 within the agent definition data structure 404. The task parameter 412 is configured to specify assigned operations and expected outputs for the corresponding agent. The task parameter 412 defines specific work items that the agent is responsible for completing within the agent-based workflow. The task parameter 412 comprises assigned operations defining actions the agent is to perform and expected outputs defining results the agent is to produce upon completion of the assigned operations. The task parameter 412 may specify tasks including, but not limited to, generating candidate enterprise use-cases implementable using available computational tools, evaluating candidate enterprise use-cases for technical feasibility and commercial viability, synthesizing agent definition data structures based on objectives defined in an idea description, executing the multi-agent system to produce outputs, evaluating outputs against qualitative evaluation criteria, and generating hypothesis data comprising proposed modifications with rationale.

The architecture 400 further comprises dependency and delegation references 414 within the agent definition data structure 404. The dependency and delegation references 414 are configured to define inter-agent relationships and task delegation strategies within the multi-agent system. The dependency and delegation references 414 specify which agents depend on outputs from other agents and how tasks are delegated among agents. The dependency and delegation references 414 enable agents to work cooperatively to achieve complex objectives. The dependency and delegation references 414 may define relationships including, but not limited to, a refinement agent delegating tasks to other agents for executing, evaluating, modifying, optimizing, and storing multi-agent configurations, a hypothesis agent depending on evaluation reports from an evaluation agent, a modification agent depending on hypotheses generated by a hypothesis agent, and a comparison agent depending on outputs generated by an execution agent.

The agent definition data structure 404 enables autonomous refinement of multi-agent system implementations by facilitating synthesis of changes to agent definitions. The agent definition data structure 404 supports modifications to the role parameter 406, the goal parameter 408, the backstory parameter 410, the task parameter 412, and the dependency and delegation references 414 through iterative optimization cycles. The modifications to the agent definition data structure 404 are based on hypotheses generated by analyzing qualitative and quantitative performance of the multi-agent system and identifying areas for improvement. The modifications to the agent definition data structure 404 are documented with reasoning behind each modification and expected improvements.

The multi-agent system definition 402 stores a plurality of agent definition data structures conforming to the agent definition data structure 404. The multi-agent system definition 402 may be modified through iterative refinement cycles wherein hypothesis agents propose enhancements to agent definitions, modification agents synthesize new variants of the multi-agent system by altering agent logic and workflow, and comparison agents compare outputs of each configuration against qualitative and quantitative metrics to identify a configuration with improved performance for further refinement. The multi-agent system definition 402 with improved performance is stored by a memory agent for referencing in future iterations and comparison against new variants.

### Initialization Process for Multi-Agent System Definition and Criteria Generation

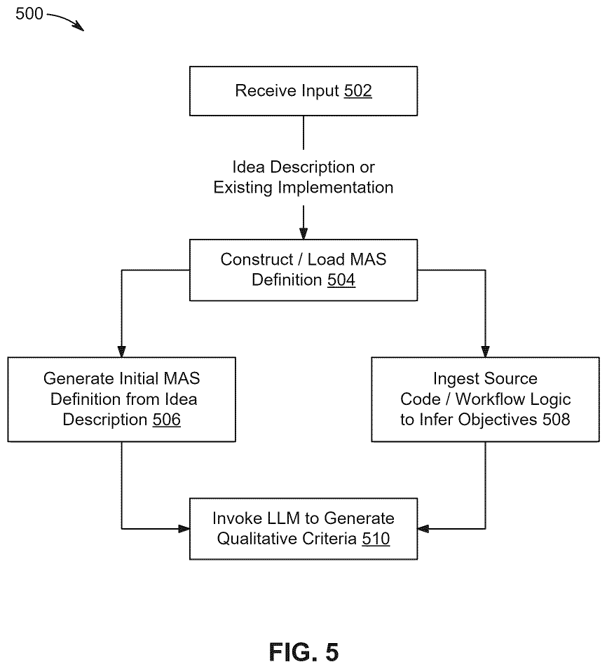

FIG. 5 illustrates an initialization process 500 for multi-agent system definition and criteria generation. The initialization process 500, also referred to as the process 500, is configured to receive input data, construct or load a multi-agent system definition, and generate qualitative evaluation criteria for subsequent optimization. The initialization process 500 implements a branched architecture wherein the process 500 handles two distinct input types: an idea description defining objectives and an existing multi-agent system implementation. The initialization process 500 provides flexibility to take an idea with or without defined qualitative criteria and generate an initial system implementation, or refine an existing multi-agent system based on given or inferred objectives. The initialization process 500 serves as a precursor to an optimization loop wherein the multi-agent system is iteratively refined based on the qualitative evaluation criteria generated during the initialization process 500.

The initialization process 500 commences at step 502 with receiving input. At step 502, an autonomous meta-framework platform is configured to receive an input comprising at least one of an idea description defining objectives or an existing multi-agent system implementation. When the input comprises the idea description defining objectives, the initialization process 500 proceeds along a first branch to generate an initial multi-agent system definition based on the idea description. When the input comprises the existing multi-agent system implementation, the initialization process 500 proceeds along a second branch to ingest source code or workflow logic and infer objectives from the existing implementation. The input received at step 502 may further comprise qualitative criteria for output evaluation, wherein the qualitative criteria may be provided with the idea description. In certain embodiments, the input received at step 502 comprises data identifying a set of available computational tools, wherein the initialization process 500 proceeds to generate candidate enterprise use-cases implementable using the available computational tools prior to generating the multi-agent system definition.

The initialization process 500 proceeds to step 504 with constructing or loading a multi-agent system definition. At step 504, the autonomous meta-framework platform is configured to either construct a new multi-agent system definition or load an existing multi-agent system definition based on the input received at step 502. When the input comprises the idea description defining objectives, step 504 initiates construction of a new multi-agent system definition by proceeding to step 506. When the input comprises the existing multi-agent system implementation, step 504 initiates loading of the existing multi-agent system definition by proceeding to step 508. The multi-agent system definition constructed or loaded at step 504 conforms to the agent definition data structure architecture 400 described with reference to FIG. 4.

The initialization process 500 proceeds along the first branch to step 506 with generating an initial multi-agent system definition from the idea description. At step 506, an implementation agent is configured to generate an initial version of the multi-agent system based on the idea description received at step 502. In cases where no initial implementation is provided, the autonomous meta-framework platform generates the initial multi-agent system definition based on the input description, synthesizing an initial agentic system that aligns with provided objectives. The implementation agent defines roles, goals, backstories, and tasks of agents involved in the target multi-agent system and develops the agents using a multi-agent framework. The implementation agent synthesizes agent definition data structures conforming to the agent definition data structure 404 described with reference to FIG. 4.

The initialization process 500 proceeds along the second branch to step 508 with ingesting source code or workflow logic to infer objectives. At step 508, the autonomous meta-framework platform is configured to analyze source code or workflow logic of the existing multi-agent system implementation to infer objectives. The autonomous meta-framework platform ingests the existing multi-agent system implementation and extracts objectives from the source code or workflow logic. The objectives inferred at step 508 are used to generate qualitative evaluation criteria at subsequent steps of the initialization process 500. The inferred objectives serve as a basis for a large language model to create qualitative criteria that align with the intended purpose and functionality of the existing multi-agent system implementation.

The initialization process 500 proceeds to step 510 with invoking a large language model to generate qualitative criteria. At step 510, the autonomous meta-framework platform is configured to generate qualitative evaluation criteria via the large language model based on the system's goals. The qualitative evaluation criteria are either inferred from the initial multi-agent system definition generated at step 506 or inferred from objectives extracted at step 508. The large language model analyzes the multi-agent system definition and generates qualitative evaluation criteria for assessing outputs from the multi-agent system. The qualitative evaluation criteria generated at step 510 comprise relevance, clarity, consistency, completeness, and depth of analysis. Relevance assesses whether outputs align with objectives identified from code analysis and whether outputs are pertinent to intended tasks and goals assigned to agents. Clarity evaluates how well output is presented and structured, and whether output is understandable and actionable for stakeholders. Consistency analyzes consistency of outputs across iterations and whether outputs reflect a stable understanding of objectives and tasks over time. Completeness checks whether outputs cover all aspects of tasks or goals specified in agent definitions and whether any critical areas or components are overlooked. Depth of analysis evaluates whether output provides comprehensive analysis with insights beyond surface-level data and whether output leads to actionable recommendations.

In addition to qualitative evaluation criteria, the large language model at step 510 may generate specific quantitative metrics to complement evaluation. The quantitative metrics comprise execution time, success rate, and benchmarking. Execution time measures time taken by the multi-agent system to produce outputs, assessing efficiency and responsiveness. Success rate quantifies the proportion of tasks completed by the multi-agent system relative to total tasks assigned, reflecting overall effectiveness. Benchmarking evaluates outputs of the multi-agent system regarding assigned tasks on a dataset with ground-truths and a benchmarking metric.

In certain embodiments, the initialization process 500 supports optional human-in-the-loop intervention after step 510. A user may revise the qualitative evaluation criteria and quantitative metrics generated by the large language model at step 510. The autonomous meta-framework platform enables human input for revising the qualitative and quantitative criteria prior to commencing the optimization loop. The initialization process 500 operates fully autonomously in absence of human input at the intervention point.

The qualitative evaluation criteria generated at step 510 serve as a basis for ongoing assessment throughout iterative optimization of the multi-agent system. As the multi-agent system iteratively improves through the optimization loop, the large language model continues to apply the qualitative evaluation criteria to evaluate each cycle's outputs, facilitating a consistent focus on quality and alignment with objectives. Upon completion of step 510, the initialization process 500 outputs a multi-agent system definition and qualitative evaluation criteria for use in subsequent optimization operations.

### Optimization Loop for Iterative Refinement of Multi-Agent Systems

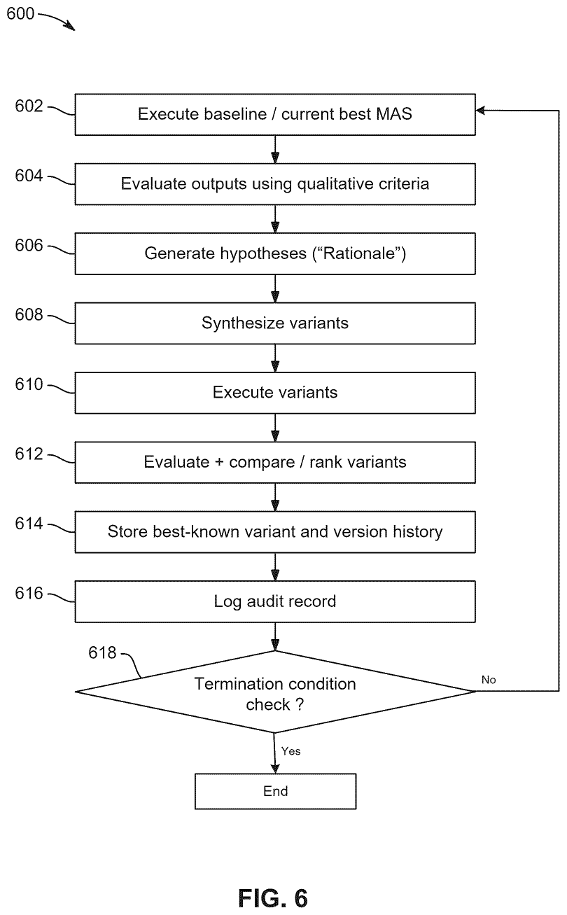

FIG. 6 illustrates an optimization loop 600 for iterative refinement of multi-agent systems. The optimization loop 600, also referred to as the process, is configured to continuously refine and optimize a multi-agent framework by generating hypotheses for improvement, modifying the multi-agent system, and iteratively comparing outputs to identify a configuration with improved performance to be used as a basis for successive iterations. The optimization loop 600 implements a feedback-improvement loop wherein the multi-agent system enhances agent roles, backstories, goals, and tasks while managing dependencies and delegations to achieve optimal performance. The optimization loop 600 operates by continuously running a cycle of execution, evaluation, hypothesis generation, modification, and comparison. Each iteration of the optimization loop 600 results in a refined version of the multi-agent system. The optimization loop 600 is entirely autonomous and can run indefinitely, refining the multi-agent system based on new inputs, goals, or changing qualitative and quantitative benchmarks.

The optimization loop 600 commences at step 602 with executing a baseline multi-agent system or a current best-performing multi-agent system. At step 602, an execution agent is configured to run the baseline multi-agent system or the current best-performing multi-agent system to produce execution outputs. The execution agent is responsible for running code, debugging, gathering outputs, and verifying successful completion of tasks for the multi-agent system. The execution agent validates and executes the multi-agent system to collect outputs and quantitative metrics. The execution agent runs the multi-agent system in a simulated or real-world environment, monitoring performance in real-time, tracking performance, collecting data, and making any necessary adjustments to optimize outcomes. In certain embodiments, the execution agent creates mockup data or simulates human-in-the-loop inputs to facilitate accurate testing. The execution outputs generated at step 602 serve as a baseline for comparison in subsequent steps of the optimization loop 600.

The optimization loop 600 proceeds to step 604 with evaluating outputs using qualitative criteria. At step 604, an evaluation agent is configured to assess quality and effectiveness of the execution outputs generated at step 602. The evaluation agent employs a large language model to assess the execution outputs against the qualitative evaluation criteria and quantitative metrics described with reference to FIG. 5. The evaluation agent identifies weaknesses and areas for improvement in the execution outputs. The evaluation agent generates an evaluation report comprising feedback on strengths and weaknesses of the multi-agent system's performance and detailing areas where the multi-agent system's output can be optimized.

The optimization loop 600 proceeds to step 606 with generating hypotheses with rationale. At step 606, a hypothesis agent is configured to propose enhancements to top-performing agent definitions, including roles, goals, backstories, and tasks, as well as interactions and workflows based on performance analysis. The hypothesis agent analyzes qualitative and quantitative performance of the current multi-agent system in producing output and identifies areas for improvement based on the evaluation report generated at step 604. The hypothesis agent generates specific hypotheses for modifying agent roles, workflows, and dependencies to address identified areas for improvement, emphasizing efficiency and alignment with defined criteria. The hypothesis agent generates hypothesis data comprising proposed modifications to agent definition data structures and rationale indicating why each proposed modification is expected to yield improved performance relative to the qualitative evaluation criteria. The rationale generated by the hypothesis agent documents reasoning behind each proposed modification and expected improvements.

The optimization loop 600 proceeds to step 608 with synthesizing variants. At step 608, a modification agent is configured to implement hypothesized changes generated at step 606 by integrating modifications to create multiple versions of the multi-agent system. The modification agent synthesizes new multi-agent system versions from top-performing variants using hypothesized changes to improve alignment with qualitative criteria. The modification agent generates new variants of the multi-agent system by altering agent logic and workflow, including agents, roles, tasks, and interactions. The modification agent generates a plurality of variant multi-agent system definitions, wherein each variant implements a different combination of proposed modifications from the hypothesis data. The modification agent documents reasoning behind each modification and expected improvements for each variant synthesized at step 608.

The optimization loop 600 proceeds to step 610 with executing variants. At step 610, the execution agent is configured to run and debug multiple variants synthesized at step 608 to collect outputs and quantitative metrics from each variant. The execution agent validates, executes, and attempts to debug the plurality of variants to generate variant execution outputs. The execution agent generates variant execution output data for each of the plurality of variants synthesized at step 608.

The optimization loop 600 proceeds to step 612 with evaluating, comparing, and ranking variants. At step 612, the evaluation agent is configured to assess quality and effectiveness of the variant execution outputs generated at step 610 regarding the qualitative evaluation criteria. A comparison agent is configured to compare outputs generated by modified systems against the baseline execution outputs from step 602 and assess whether and how the modified systems outperform the baseline. The comparison agent compares metrics generated by modified systems against a current best-performing configuration, and ranks the plurality of variants based on the qualitative evaluation criteria and quantitative metrics. The comparison agent identifies a variant that yields improved performance relative to the current best-performing configuration. The comparison agent generates a comparison report detailing performance of each variant relative to the baseline and identifying the variant with improved performance for storage at subsequent steps.

The optimization loop 600 proceeds to step 614 with storing a variant with improved performance and version history. At step 614, a memory agent is configured to store and retrieve best-performing variants and outputs of the best-performing variants in a long-term memory for referencing the best-performing variants in future iterations. The memory agent stores the variant identified at step 612 as a reference multi-agent system definition. The memory agent maintains a version history of multi-agent system definitions across optimization iterations. The reference multi-agent system definition stored at step 614 serves as the current best-performing multi-agent system for subsequent iterations of the optimization loop 600.

The optimization loop 600 proceeds to step 616 with logging an audit record. At step 616, a documentation agent is configured to record all changes, decisions, and performance outcomes throughout the refinement process. The documentation agent logs each workflow step, including hypotheses generated at step 606, modifications synthesized at step 608, evaluations performed at step 604 and step 612, comparisons conducted at step 612, and decisions made with rationale throughout the optimization loop 600. The documentation agent compiles the iterative process, detailing changes, outcomes, and insights gained during optimization. The audit record logged at step 616 provides valuable insights for future developments and applications in AI-driven workflows.

The optimization loop 600 proceeds to step 618 with a termination condition check. At step 618, the optimization loop 600 determines whether a termination condition is satisfied. The termination condition comprises at least one of a threshold condition, a maximum iterations condition, and a saturation condition. The threshold condition is satisfied when performance of the multi-agent system exceeds a predefined performance threshold based on the qualitative evaluation criteria and quantitative metrics. The maximum iterations condition is satisfied when a predefined maximum number of optimization iterations has been completed. The saturation condition is satisfied when performance improvements between successive iterations fall below a predefined improvement threshold, indicating that the multi-agent system has reached optimal or near-optimal performance. When the termination condition is satisfied at step 618, the optimization loop 600 terminates and outputs a final optimized multi-agent system definition. When the termination condition is not satisfied at step 618, the optimization loop 600 returns to step 602 to execute the reference multi-agent system definition stored at step 614 as the current best-performing multi-agent system, and the optimization loop 600 continues iteratively until the termination condition is satisfied.

The optimization loop 600 enables continuous refinement and optimization of a multi-agent framework through iterative feedback-improvement cycles. The optimization loop 600 provides autonomous improvement wherein the optimization loop 600 does not require human intervention to improve and optimize multi-agent systems. The optimization loop 600 provides efficiency by automating refinement of agent systems, reducing time and cost associated with manual optimization. The optimization loop 600 provides scalability wherein the optimization loop 600 can scale across multiple domains and industries by adjusting agent logic to suit different goals or markets.

In certain embodiments, the optimization loop 600 supports optional human-in-the-loop intervention at predefined intervention points. A first intervention point occurs after step 604, wherein a user may revise the qualitative evaluation criteria. A second intervention point occurs after step 606, wherein a user may select hypotheses for implementation. A third intervention point occurs after step 612, wherein a user may select the variant with improved performance for storage. The optimization loop 600 operates fully autonomously in absence of human input at any or all of the intervention points.

### Use-Case Generation Process

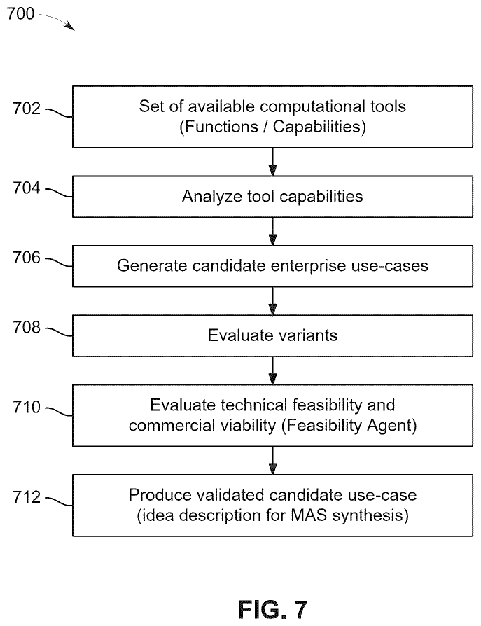

FIG. 7 illustrates a use-case generation process 700 for autonomous enterprise use-case ideation from available computational tools. The use-case generation process 700, also referred to as the process 700, is configured to autonomously generate commercially and technically feasible enterprise use-cases leveraging available tools in a multi-agent artificial intelligence setting. The use-case generation process 700 implements an ideation architecture wherein the process 700 analyzes capabilities of available computational tools, generates candidate enterprise use-cases implementable using the available computational tools, and evaluates the candidate enterprise use-cases for technical feasibility and commercial viability. The use-case generation process 700 serves as a precursor to multi-agent system synthesis wherein validated candidate use-cases are converted into operational multi-agent systems.

The use-case generation process 700 commences at step 702 with a set of available computational tools. At step 702, the autonomous meta-framework platform receives data identifying a set of available computational tools. The set of available computational tools comprises functions and capabilities that can be leveraged for multi-agent system applications. The available computational tools may include, but are not limited to, SerperDevTool for web searching, ScrapeWebsiteTool for data extraction, and other tools for gathering information, generating reports, performing market research, and adapting workflows. Each available computational tool in the set of available computational tools has associated functions defining operations that the available computational tool can perform and capabilities defining the scope and limitations of the available computational tool. The set of available computational tools received at step 702 defines a boundary of technical possibilities for candidate enterprise use-cases generated at subsequent steps.

The use-case generation process 700 proceeds to step 704 with analyzing tool capabilities. At step 704, the autonomous meta-framework platform is configured to analyze capabilities of the available computational tools received at step 702. The autonomous meta-framework platform examines functions and capabilities of each available computational tool to determine operations that can be performed, data types that can be processed, integrations that are supported, and limitations that constrain use of the available computational tool. The analysis performed at step 704 identifies potential combinations of available computational tools that can be leveraged to implement enterprise use-cases and identifies technical constraints associated with the available computational tools.

The use-case generation process 700 proceeds to step 706 with generating candidate enterprise use-cases. At step 706, an innovation agent is configured to generate candidate enterprise use-cases implementable using the available computational tools analyzed at step 704. The innovation agent generates disruptive business models by tracking emerging trends and technologies and identifies potential areas for multi-agent system applications that can be implemented using the available computational tools. The innovation agent generates a plurality of candidate enterprise use-cases based on the tool capabilities analyzed at step 704, wherein each candidate enterprise use-case comprises a use-case description defining objectives and intended outcomes, a tool utilization plan specifying which available computational tools are to be leveraged, and an industry application context identifying target industries and market segments.

The use-case generation process 700 proceeds to step 708 with evaluating variants. At step 708, the autonomous meta-framework platform is configured to evaluate the plurality of candidate enterprise use-cases generated at step 706. The evaluation performed at step 708 assesses each candidate enterprise use-case against preliminary feasibility criteria to identify candidates that warrant detailed feasibility analysis. The evaluation performed at step 708 filters candidate enterprise use-cases based on alignment with available tool capabilities, potential market applicability, and preliminary technical viability.

The use-case generation process 700 proceeds to step 710 with evaluating technical feasibility and commercial viability. At step 710, a feasibility agent is configured to evaluate technical and commercial feasibility of the candidate enterprise use-cases filtered at step 708. The feasibility agent determines whether candidate enterprise use-cases can be practically implemented with available tools and are viable in the current market. The feasibility agent evaluates each candidate enterprise use-case based on technical constraints, including availability of required computational tools, compatibility of tool integrations, and framework support, and commercial considerations, including scalability, return on investment (ROI) potential, and market demand. The feasibility agent provides feedback to the innovation agent to refine ideas iteratively. The feasibility agent generates a feasibility assessment for each candidate enterprise use-case, indicating whether the candidate enterprise use-case is technically feasible and commercially viable for implementation.

The use-case generation process 700 proceeds to step 712 with producing a validated candidate use-case. At step 712, the autonomous meta-framework platform is configured to produce a validated candidate use-case based on the feasibility assessments generated at step 710. The validated candidate use-case comprises a candidate enterprise use-case that has been assessed as technically feasible and commercially viable by the feasibility agent. The validated candidate use-case serves as an idea description for multi-agent system synthesis at subsequent stages of the autonomous meta-framework workflow. The validated candidate use-case output at step 712 comprises objectives defining intended outcomes, tool utilization specifications, industry context, and feasibility confirmation.

The validated candidate use-case produced at step 712 is passed to a synthesis stage wherein an implementation agent converts the validated candidate use-case into an operational multi-agent system. The implementation agent synthesizes agent definition data structures conforming to the agent definition data structure 404 described with reference to FIG. 4.

The use-case generation process 700 enables autonomous use-case generation wherein the use-case generation process 700 autonomously generates commercially and technically feasible enterprise use-cases without human intervention. In certain embodiments, the use-case generation process 700 operates iteratively wherein multiple candidate enterprise use-cases are generated, evaluated, and refined through feedback cycles between the innovation agent and the feasibility agent until one or more validated candidate use-cases are produced that satisfy technical feasibility and commercial viability criteria.

### Variant Comparison and Selection Architecture

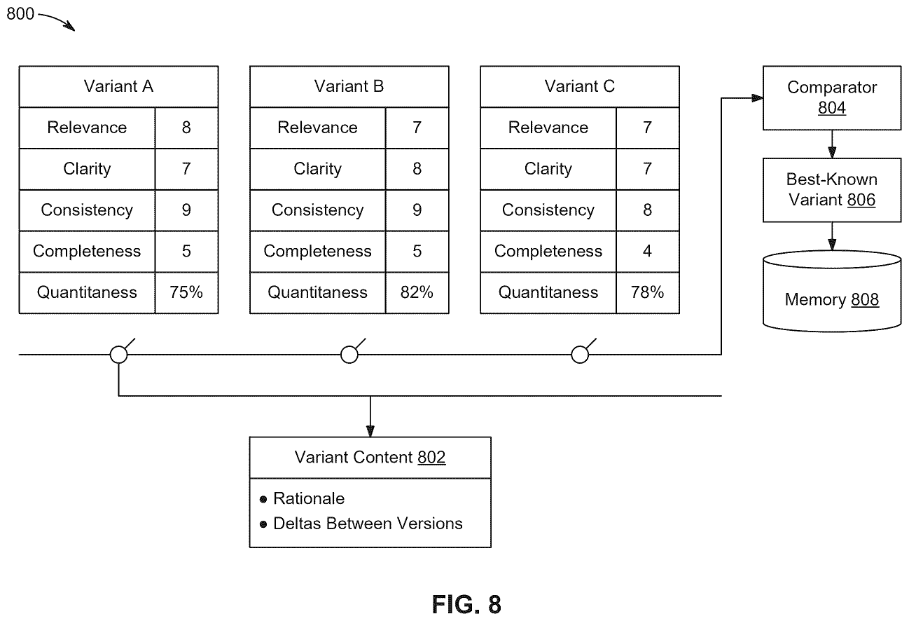

FIG. 8 illustrates a variant comparison and selection architecture 800 for multi-agent system optimization. The variant comparison and selection architecture 800, also referred to as the architecture 800, is configured to compare outputs generated by multiple multi-agent system variants against qualitative evaluation criteria and quantitative metrics, rank the variants based on performance, and store a variant with improved performance for use in subsequent optimization iterations. The architecture 800 implements a comparison framework wherein a plurality of variants are evaluated against predefined qualitative performance criteria and a comparator identifies a variant that yields improved performance relative to other variants.

The architecture 800 comprises a plurality of variants, including variant A, variant B, and variant C. Each variant in the plurality of variants represents a distinct multi-agent system configuration synthesized by a modification agent during an optimization loop as described with reference to FIG. 6. The modification agent generates new variants of the multi-agent system by altering agent logic and workflow, including agents, roles, tasks, and interactions. Each variant implements a different combination of proposed modifications from hypothesis data generated by a hypothesis agent. The plurality of variants are executed by an execution agent to produce variant execution outputs for comparison.

Each variant in the plurality of variants is evaluated against the qualitative evaluation criteria and quantitative metrics described with reference to FIG. 5. Variant A is evaluated and assigned a relevance score of 8, a clarity score of 7, a consistency score of 9, a completeness score of 5, and a quantitativeness score of 75%. Variant B is evaluated and assigned a relevance score of 7, a clarity score of 8, a consistency score of 9, a completeness score of 5, and a quantitativeness score of 82%. Variant C is evaluated and assigned a relevance score of 7, a clarity score of 7, a consistency score of 8, a completeness score of 4, and a quantitativeness score of 78%. The scores assigned to each variant represent performance assessments generated by an evaluation agent utilizing a large language model to assess quality and effectiveness of outputs from each variant.

The architecture 800 further comprises variant content 802. The variant content 802 is configured to store metadata associated with each variant in the plurality of variants. The variant content 802 comprises rationale and deltas between versions. The rationale comprises documentation of reasoning behind each modification implemented in the corresponding variant and expected improvements resulting from the modification. The rationale is generated by the hypothesis agent when proposing enhancements to agent definitions and is documented by the modification agent when synthesizing the variant. The deltas between versions comprise records of differences between each variant and a previous version of the multi-agent system, identifying specific changes made to agent roles, goals, backstories, tasks, delegation strategies, and dependencies relative to a reference multi-agent system definition. The variant content 802 enables traceability of modifications throughout the optimization process and supports analysis of which modifications contribute to performance improvements.

The architecture 800 further comprises a comparator 804. The comparator 804 is configured to compare outputs generated by modified systems against a current configuration with improved performance and assess whether and how the modified systems outperform the current configuration. The comparator 804 is implemented by a comparison agent configured to compare metrics generated by modified systems against the current configuration with improved performance, and rank the plurality of variants. The comparator 804 receives evaluation scores for each variant in the plurality of variants and analyzes the evaluation scores to identify a variant that yields improved performance relative to other variants.

The comparator 804 applies a ranking algorithm to order the plurality of variants based on aggregate performance across the qualitative evaluation criteria and quantitative metrics. The ranking algorithm may comprise weighted aggregation wherein different weights are assigned to different evaluation criteria based on relative importance, threshold-based filtering wherein variants failing to meet minimum performance thresholds are eliminated from consideration, and multi-criteria optimization wherein trade-offs between different evaluation criteria are balanced to identify a variant with optimal overall performance. Based on the evaluation scores illustrated in the architecture 800, the comparator 804 identifies variant B as the variant with improved performance, achieving the highest quantitativeness score of 82% among the plurality of variants.

The architecture 800 further comprises a best-known variant 806. The best-known variant 806 is configured to represent the multi-agent system configuration identified by the comparator 804 as having improved performance relative to other variants. The best-known variant 806 comprises a reference multi-agent system definition that serves as a baseline for subsequent optimization iterations. The best-known variant 806 is updated after each optimization iteration when the comparator 804 identifies a new variant that yields improved performance relative to a current best-known variant. The best-known variant 806 comprises agent definition data structures conforming to the agent definition data structure 404 described with reference to FIG. 4.

The architecture 800 further comprises memory 808. The memory 808 is configured to store and retrieve best-performing variants and outputs of the best-performing variants in a long-term memory for referencing the best-performing variants in future iterations. The memory 808 is implemented by a memory agent configured to store the best-known variant 806 and associated metadata including evaluation scores, variant content 802, and version history. The memory 808 enables the optimization loop to reference stored configurations in future iterations and compare the stored configurations against new variants. The memory 808 maintains a version history of multi-agent system definitions across optimization iterations, enabling analysis of performance trends and identification of modifications that contribute to sustained improvements.

In certain embodiments, the architecture 800 supports optional human-in-the-loop intervention wherein a user may select the variant with improved performance for storage in the memory 808, overriding the selection made by the comparator 804 based on domain expertise or strategic considerations. The architecture 800 operates fully autonomously in absence of human input at the intervention point.

In certain embodiments, the autonomous meta-framework platform and the target multi-agent system illustrated in FIGS. 1-8 are implemented on an artificial intelligence platform that employs one or more machine learning models as inference and reasoning engines for generating, evaluating, and refining multi-agent system definitions. The artificial intelligence platform provides computational support for analyzing idea descriptions, existing multi-agent system implementations, agent definition data structures, and execution outputs by transforming symbolic, textual, or structured inputs into numerical representations suitable for model-based inference. The artificial intelligence platform may utilize transformer-based architectures, neural networks, or other learning models to process agent roles, goals, backstory parameters expressed in natural language, task definitions, dependency relationships, qualitative evaluation criteria, hypothesis data, and execution results. Within this implementation context, model inference is applied during initialization, criteria generation, evaluation, hypothesis formulation, variant synthesis, comparison, and ranking operations depicted across the figures, enabling the platform to derive qualitative judgments, generate rationale, and assess relative performance of multi-agent system variants. The artificial intelligence platform may further include embedding mechanisms, attention mechanisms, encoder-decoder structures, and memory representations to capture contextual relationships among agents, objectives, tasks, and outputs over iterative refinement cycles. Accordingly, the system components and processes described with reference to FIGS. 1-8 may be executed using one or more artificial intelligence models operating as configurable computational components within the platform, while remaining independent of any specific model architecture, training methodology, or learning paradigm.

### Machine Learning Techniques

Some implementations of the technology disclosed relate to using a Transformer model to provide an AI system. In particular, the technology disclosed proposes an AI management system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically only have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLAMA versions, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, ViTB/16-FRCNN, ViT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

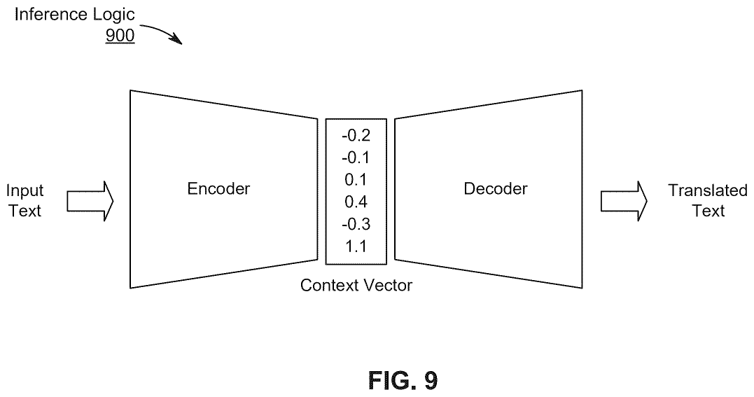

FIG. 9 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

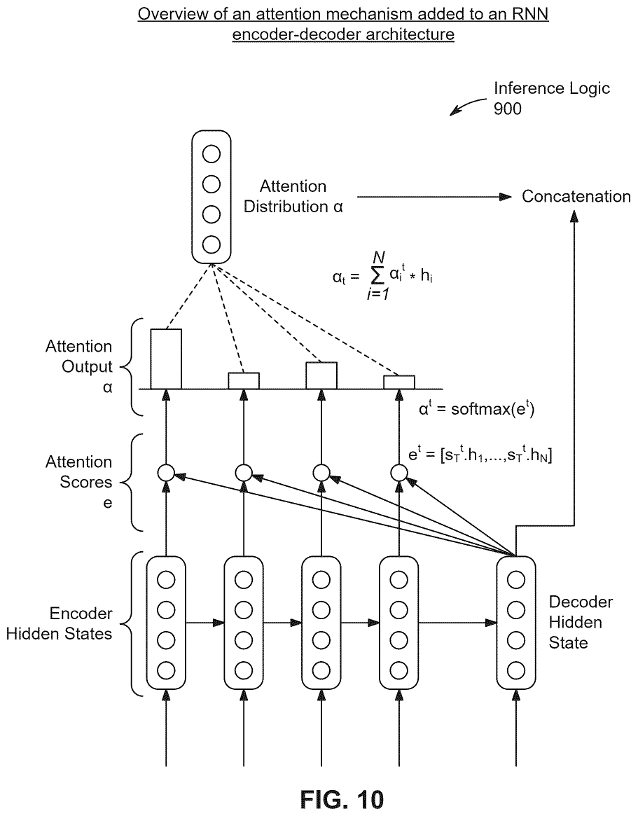

Attention mechanisms distinguish Transformers from other machine learning models. The attention mechanism provides a solution for the vanishing gradient problem. FIG. 10 shows an overview of an attention mechanism added to an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

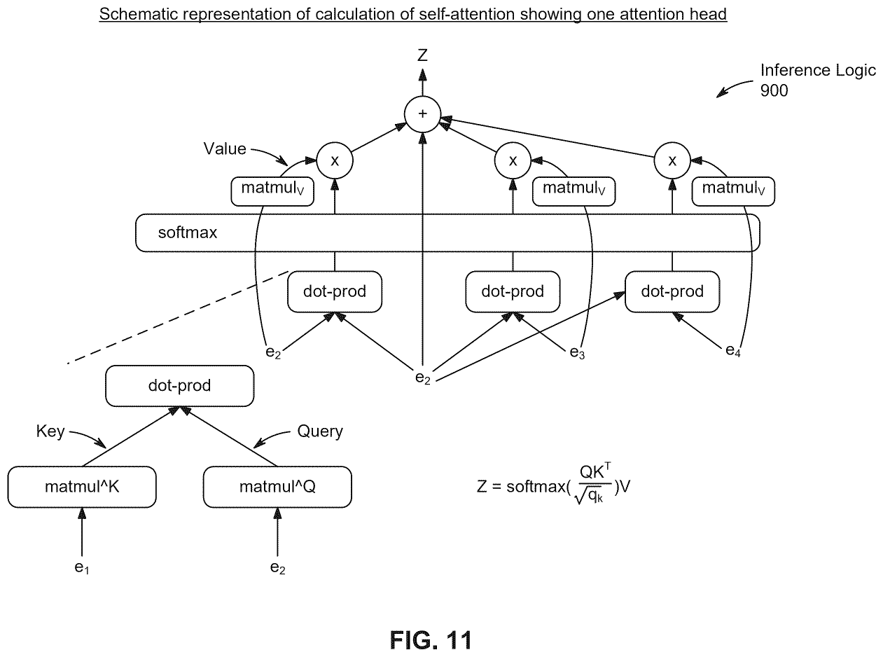

Multi-headed attention is executed in the Transformer. FIG. 11 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

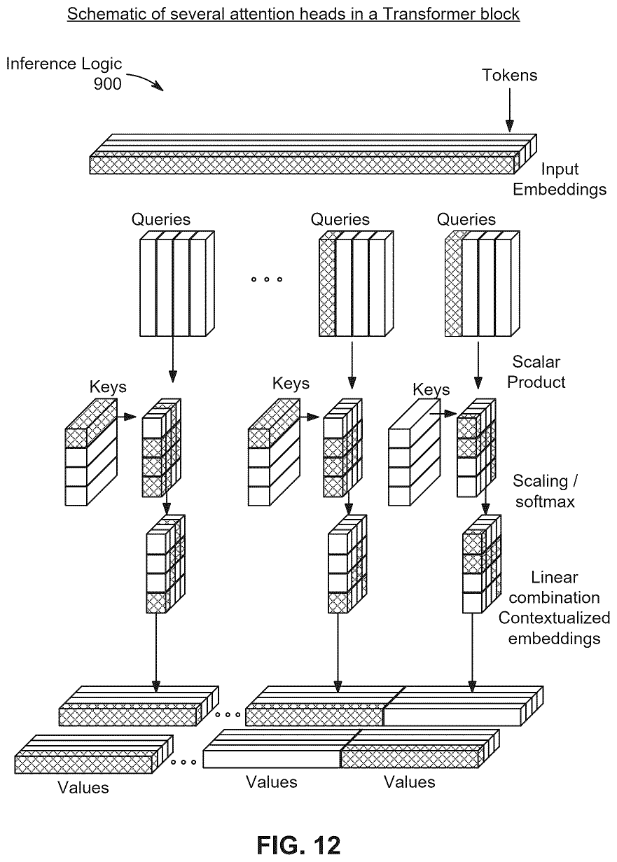

FIG. 12 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and d is the hidden representation of each element (also called the hidden vector). Attention is then computed as:

$$Attention ( Q , K , V ) = SoftMax ( \frac{{QK}^{T}}{\sqrt{dk}} ) V$$

where Q, K, V are computed as:

$$X \cdot {W}_{Q} , X \cdot {W}_{K} , X \cdot {W}_{V}$$

X is the input matrix and W_{Q}, W_{K}, W_{V} are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

$$MultiHeadAttention ( Q , K , V ) = [ {head}_{1} , … , {head}_{h} ] {W}_{0} where {head}_{i} = Attention ( {QW}_{i}^{Q} , {KW}_{i}^{K} , {VW}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

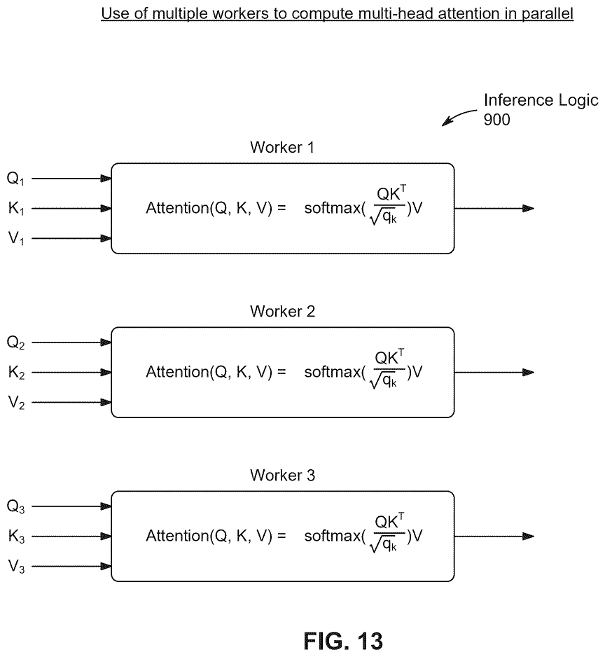

As shown in FIG. 13, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

$$a \cdot b \cdot c$$

For matrices of shape (a, b) and (c, d), to obtain values Q, K, V, we need to compute the operations:

$$X \cdot {W}_{Q} , X \cdot {W}_{K} , X \cdot WV$$

The matrix X is of shape (n, d) where n is the number of patches and d is the hidden vector dimension. The weights W_{Q}, W_{K}, W_{V} are all of shape (d, d). Omitting the constant factor 3, the resulting complexity is:

$$n \cdot {d}^{2}$$

We can proceed to the estimation of the complexity of the attention function itself, i.e., of

$$SoftMax ( \frac{{QK}^{T}}{\sqrt{dk}} ) V .$$

The matrices Q and K are both of shape (n, d). The transposition operation does not influence the asymptotic complexity of computing the dot product of matrices of shapes (n, d)·(d, n), therefore its complexity is:

$${n}^{2} \cdot d$$

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product

$$SoftMax ( \frac{{QK}^{T}}{\sqrt{dk}} ) \cdot V$$

is between matrices of shapes (n, n) and (n, d) and so its complexity is:

$${n}^{2} \cdot d$$

The final asymptotic complexity of scaled dot-product attention is obtained by summing the complexities of computing Q, K, V, and of the following attention function:

$$n \cdot {d}^{2} + {n}^{2} \cdot d .$$

The asymptotic complexity of multi-head attention is the same since the original input matrix X is projected into h matrices of shapes

$$( n , \frac{d}{h} ) ,$$

where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

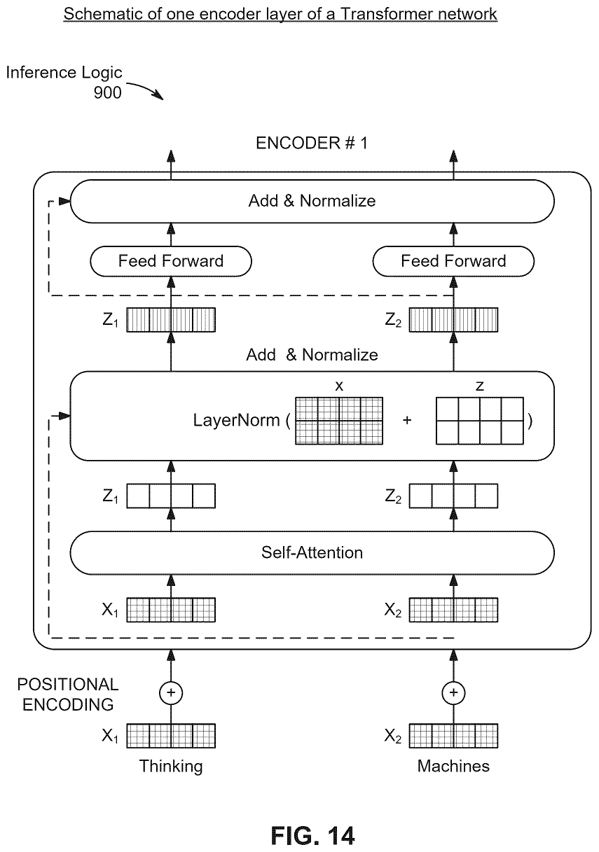

FIG. 14 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

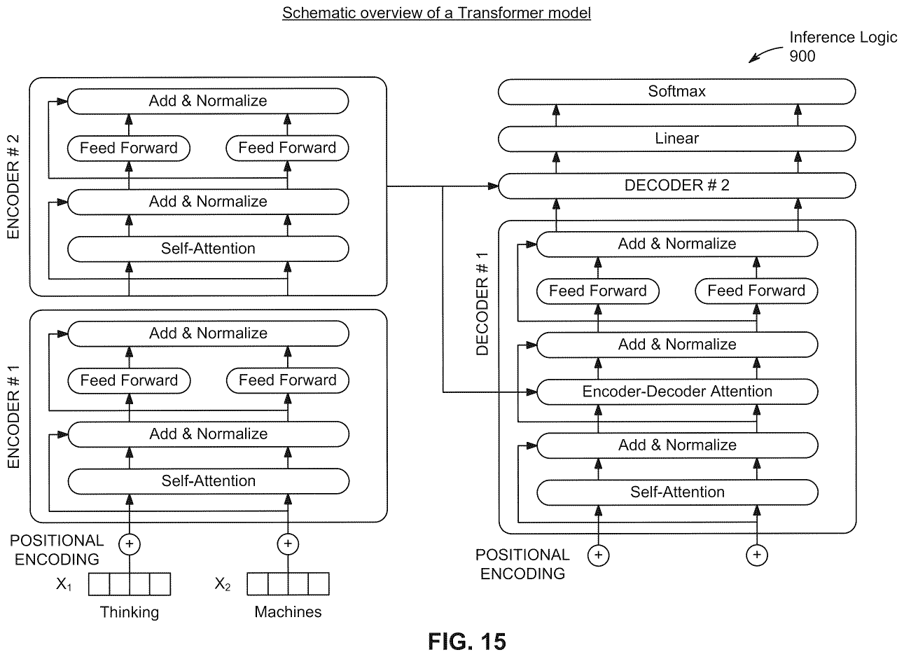

FIG. 15 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

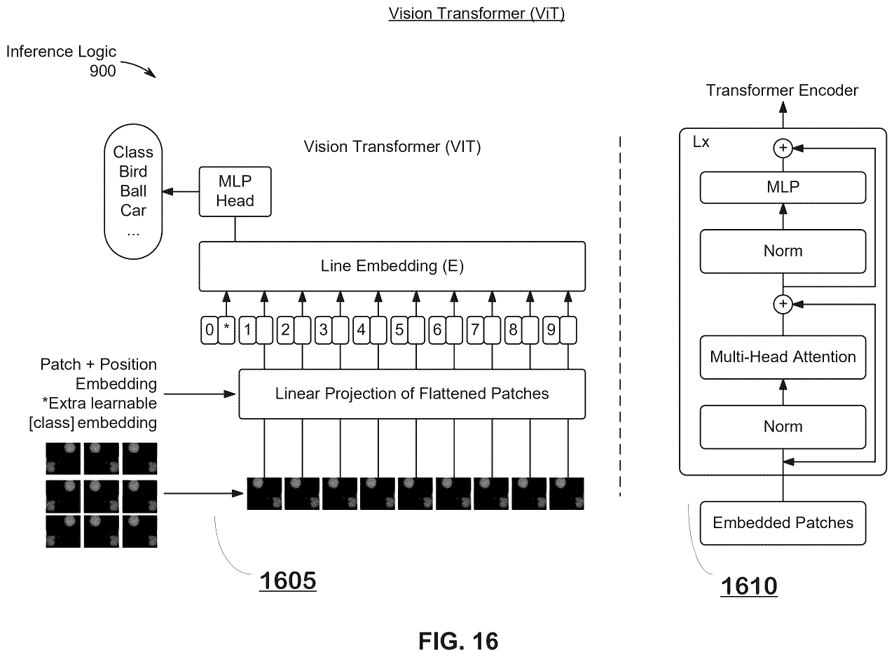

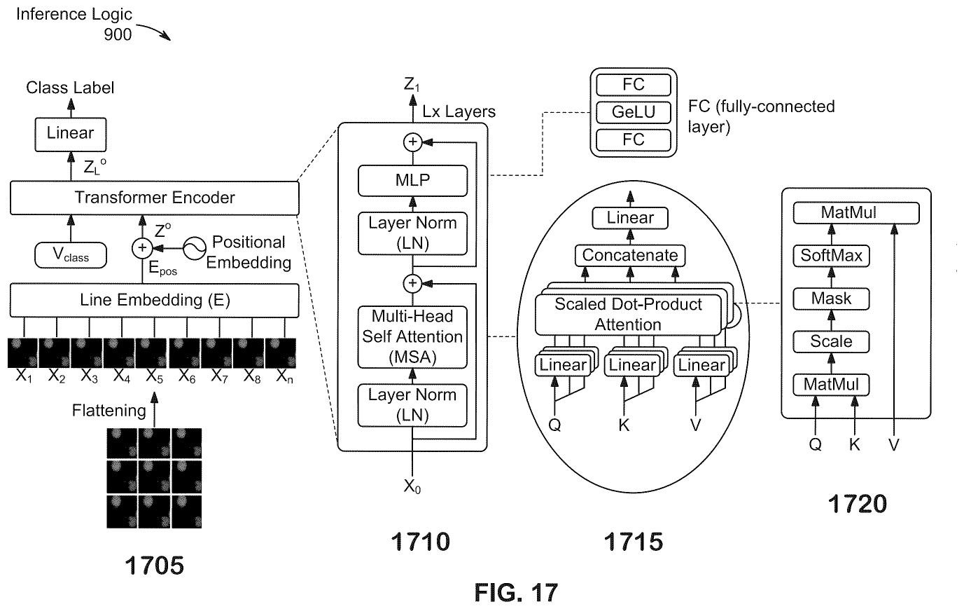

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIGS. 16 (1605 and 1610) and FIGS. 17 (1705, 1710, 1715 and 1720). Unfortunately, important positional information is lost because image sets are position-invariant. This problem is solved by adding a learned positional encoding into the image patches.

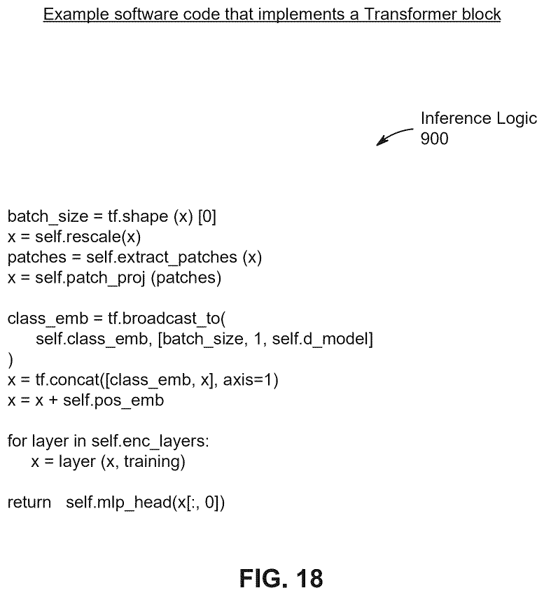

The computations of the ViT architecture can be summarized as follows. The first layer of a ViT extracts a fixed number of patches from an input image (1605 in FIG. 16). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 18.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block (1610) in FIG. 16, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the technology disclosed, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### CLAUSES

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses.

### Artificial Intelligence System Implementation

The system described in conjunction with FIG. 2 comprises one or more subsystems based on Artificial Intelligence. Implementation of the subsystems based on the Artificial Subsystems is illustrated by FIGS. 10 to 19.

Some implementations of the technology disclosed relate to using a Transformer model to provide an AI system. In particular, the technology disclosed proposes a parallel input, parallel output (PIPO) AI system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically only have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLAMA versions, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, ViTB/16-FRCNN, ViT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depth-wise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

FIG. 10 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

Attention mechanisms distinguish Transformers from other machine learning models. The attention mechanism provides a solution for the vanishing gradient problem. FIG. 11 shows an overview of an attention mechanism added onto an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

Multi-headed attention is executed in the Transformer. FIG. 12 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

FIG. 13 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and d is the hidden representation of each element (also called the hidden vector). Attention is then computed as:

$$Attention ( Q , K , V ) = SoftMax ( \frac{{QK}^{T}}{\sqrt{dk}} ) V$$

where Q, K, V are computed as:

$$X \cdot {W}_{Q} , X \cdot {W}_{K} , X \cdot {W}_{V}$$

X is the input matrix and WQ, WK, WV are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

$$MultiHeadAttention ( Q , K , V ) = [ head 1 , … , headh ] W 0 where headi = Attention ( {QW}_{i}^{Q} , {KW}_{i}^{K} , {VW}_{i}^{V} )$$

The outputs of all heads are concatenated together and projected again using the learned weights matrix W0 to match the dimensions expected by the next block of heads or the output of the Transformer. Using the multi-head attention instead of the simpler scaled dot-product attention enables Transformers to jointly attend to information from different representation subspaces at different positions.

As shown in FIG. 14, one can use multiple workers to compute the multi-head attention in parallel, as the respective heads compute their outputs independently of one another. Parallel processing is one of the advantages of Transformers over RNNs.

As shown in FIG. 14, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

$$a \cdot b \cdot c$$

For matrices of shape (a, b) and (c, d), to obtain values Q, K, V, we need to compute the operations:

$$X \cdot WQ , X \cdot WK , X \cdot WV$$

The matrix X is of shape (n, d) where n is the number of patches and d is the hidden vector dimension. The weights WQ, WK, WV are all of shape (d, d). Omitting the constant factor 3, the resulting complexity is:

$$n \cdot d 2$$

We can proceed to the estimation of the complexity of the attention function itself, i.e., of

$$SoftMax ( \frac{{QK}^{T}}{\sqrt{dk}} ) V .$$

The matrices Q and K are both of shape (n, d). The transposition operation does not influence the asymptotic complexity of computing the dot product of matrices of shapes (n, d)·(d, n), therefore its complexity is:

$$n 2 \cdot d$$

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product

$$SoftMax ( \frac{{QK}^{T}}{\sqrt{dk}} ) V$$

is between matrices of shapes (n, n) and (n, d) and so its complexity is:

$$n 2 \cdot d$$

The final asymptotic complexity of scaled dot-product attention is obtained by summing the complexities of computing Q, K, V, and of the following attention function:

$$n \cdot d 2 + n 2 \cdot d .$$

The asymptotic complexity of multi-head attention is the same since the original input matrix X is projected into h matrices of shapes

$$( n , \frac{d}{h} ) ,$$

where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

FIG. 15 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

FIG. 16 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIG. 17, and FIG. 18. Unfortunately, important positional information is lost because image sets are position-invariant. This problem is solved by adding a learned positional encoding into the image patches.

The computations of the ViT architecture can be summarized as follows. The first layer of a ViT extracts a fixed number of patches from an input image (17). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 18.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block in FIG. 17, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### Computer System

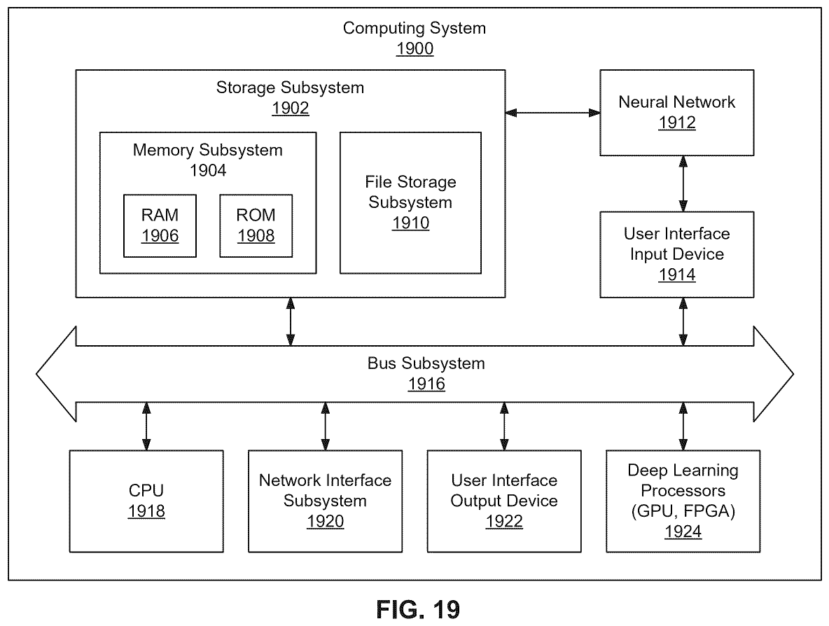

FIG. 19 shows an example computer system 1900 that can be used to implement the technology disclosed. Computer system 1900 includes at least one central processing unit (CPU) 1918 that communicates with a number of peripheral devices via bus subsystem 1916. These peripheral devices can include a storage subsystem 1902 including, for example, memory devices and a file storage subsystem 1910, user interface input devices 1914, user interface output devices 1922, and a network interface subsystem 1920. The input and output devices allow user interaction with computer system 1900. Network interface subsystem 1920 provides an interface to outside networks, including an interface to corresponding interface devices in other computer systems.

In one implementation, the disclosed AI system(s) are communicably linked to the storage subsystem 1902 and the user interface input devices 1914.

User interface input devices 1914 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1900.

User interface output devices 1922 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1900 to the user or to another machine or computer system.

Storage subsystem 1902 stores programming and data constructs that provide the functionality of some or all of the modules and methods described herein. These software modules are generally executed by processors 1918.

Deep Learning Processors 1924 can be graphics processing units (GPUs), field-programmable gate arrays (FPGAs), application-specific integrated circuits (ASICs), and/or coarse-grained reconfigurable architectures (CGRAs). Processors 1918 can be hosted by a deep learning cloud platform such as Google Cloud Platform™, Xilinx™, and Cirrascale™ Examples of processors 1918 include Google's Tensor Processing Unit (TPU)™, rackmount solutions like GX4 Rackmount Series™, GX13 Rackmount Series™, NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 1904 used in the storage subsystem 1902 can include a number of memories including a main random access memory (RAM) 1906 for storage of instructions and data during program execution and a read only memory (ROM) 1908 in which fixed instructions are stored. A file storage subsystem 1910 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1910 in the storage subsystem 1902, or in other machines accessible by the processor.

Bus subsystem 1916 provides a mechanism for letting the various components and subsystems of computer system 1900 communicate with each other as intended. Although bus subsystem 1916 is shown schematically as a single bus, alternative implementations of the bus subsystem can use multiple busses.

Computer system 1900 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1900 depicted in FIG. 19 is intended only as a specific example for purposes of illustrating the preferred implementations of the technology disclosed. Many other configurations of computer system 1900 are possible having more or less components than the computer system depicted in FIG. 19.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network 1912. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the technology disclosed, including linear classifiers, support vector machines (SVM), or neural networks 1912 such as recurrent neural networks (RNN).

Suitable artificial neural networks 1912 include but are not limited to a feedforward neural network a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The technology disclosed may be embodied as a system, a method, and/or a computer program product. The computer program product may include a computer readable storage medium (or media) having computer readable program instructions thereon for causing a processor to carry out aspects of the technology disclosed.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

FIG. 19 is a schematic of an exemplary computing node. Computing node 1900 is only one example of a suitable computing node and is not intended to suggest any limitation as to the scope of use or functionality of implementations described herein. Regardless, computing node 1900 is capable of being implemented and/or performing any of the functionality set forth hereinabove.

In computing node 1900 there is a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 19, computer system/server in computing node 1900 is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory may include at least one program product having a set (e.g., at least one) of program modules that are configured to carry out the functions of implementations of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of implementations as described herein.

Computer readable program instructions for carrying out operations of the technology disclosed may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the technology disclosed.

Aspects of the technology disclosed are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the technology disclosed. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### CLAUSES

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections, these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

We disclose clauses herein:

1. A system for autonomous generation and optimization of a target multi-agent system, the system comprising:
one or more processors; and
a memory storing instructions that, when executed by the one or more processors, cause the system to:
   receive, as an input, data defining objectives for the target multi-agent system;
   generate a multi-agent system definition comprising a plurality of agent definition data structures, each agent definition data structure comprising a backstory parameter expressed in natural language;
   generate qualitative evaluation criteria by analyzing the multi-agent system definition using a large language model; and
   iteratively optimize the multi-agent system definition by generating hypothesis data comprising proposed modifications, synthesizing variants based on the proposed modifications, and evaluating the variants against the qualitative evaluation criteria.

2. A computer-implemented method for autonomous generation and optimization of multi-agent systems, the method comprising:
receiving an input defining objectives for a target multi-agent system;
generating a multi-agent system definition comprising a plurality of agent definition data structures, each agent definition data structure comprising a backstory parameter expressed in natural language;
generating qualitative evaluation criteria by analyzing the multi-agent system definition using a large language model; and
iteratively optimizing the multi-agent system definition by generating hypothesis data comprising proposed modifications, synthesizing variants based on the proposed modifications, and evaluating the variants against the qualitative evaluation criteria.

3. A non-transitory computer-readable medium storing instructions that, when executed by one or more processors, cause the one or more processors to perform operations comprising:
receiving an input defining objectives for a target multi-agent system;
generating a multi-agent system definition comprising a plurality of agent definition data structures, each agent definition data structure comprising a backstory parameter expressed in natural language;
generating qualitative evaluation criteria by analyzing the multi-agent system definition using a large language model; and
iteratively optimizing the multi-agent system definition by generating hypothesis data comprising proposed modifications, synthesizing variants based on the proposed modifications, and evaluating the variants against the qualitative evaluation criteria.

4. A system for autonomous generation and optimization of a target multi-agent system, the system comprising:
one or more processors; and
a memory storing instructions that, when executed by the one or more processors, cause the system to:
   receive, as an input, an idea description defining objectives for the target multi-agent system;
   generate a multi-agent system definition comprising a plurality of agent definition data structures, each agent definition data structure comprising a backstory parameter expressed in natural language that defines an expertise domain, a behavioral context, and a decision-making rationale for a corresponding agent;
   generate qualitative evaluation criteria by analyzing the multi-agent system definition using a large language model, wherein the qualitative evaluation criteria are derived without requiring human-specified evaluation parameters; and
   iteratively optimize the multi-agent system definition by generating hypothesis data comprising proposed modifications with rationale, synthesizing variants based on the proposed modifications, and evaluating the variants against the qualitative evaluation criteria.

5. A system for autonomous generation and optimization of a target multi-agent system, the system comprising:
one or more processors; and
a memory storing instructions that, when executed by the one or more processors, cause the system to:
   receive an input comprising at least one of: (i) data identifying a set of available computational tools, (ii) an idea description defining objectives, or (iii) an existing multi-agent system implementation;
   generate a multi-agent system definition comprising a plurality of agent definition data structures, each agent definition data structure comprising a backstory parameter expressed in natural language that defines an expertise domain, a behavioral context, and a decision-making rationale for a corresponding agent;
   generate qualitative evaluation criteria by analyzing the multi-agent system definition using a large language model, wherein the qualitative evaluation criteria are derived without requiring human-specified evaluation parameters; and
   iteratively optimize the multi-agent system definition by generating hypothesis data comprising proposed modifications with rationale, synthesizing variants based on the proposed modifications, and evaluating the variants against the qualitative evaluation criteria.

6. A system for autonomous enterprise use-case generation and multi-agent system optimization, the system comprising:
one or more processors; and
a memory storing instructions that, when executed by the one or more processors, cause the system to:
   receive data identifying a set of available computational tools;
   analyze capabilities of the available computational tools;
   autonomously generate candidate enterprise use-cases implementable using the available computational tools;
   evaluate the candidate enterprise use-cases for technical feasibility and commercial viability;
   generate a multi-agent system definition comprising a plurality of agent definition data structures for a validated candidate enterprise use-case, each agent definition data structure comprising a backstory parameter expressed in natural language;
   generate qualitative evaluation criteria by analyzing the multi-agent system definition using a large language model; and
   iteratively optimize the multi-agent system definition by generating hypothesis data comprising proposed modifications, synthesizing variants based on the proposed modifications, and evaluating the variants against the qualitative evaluation criteria.

7. A computer-implemented method for autonomous optimization of an existing multi-agent system, the method comprising:
receiving an existing multi-agent system implementation comprising source code or workflow logic;
analyzing the source code or workflow logic of the existing multi-agent system implementation to infer objectives;
generating qualitative evaluation criteria by deriving the qualitative evaluation criteria from the inferred objectives using a large language model, wherein the qualitative evaluation criteria are derived without requiring human-specified evaluation parameters;
generating a multi-agent system definition comprising a plurality of agent definition data structures based on the existing multi-agent system implementation, each agent definition data structure comprising a backstory parameter expressed in natural language that defines an expertise domain, a behavioral context, and a decision-making rationale for a corresponding agent; and
iteratively optimizing the multi-agent system definition by generating hypothesis data comprising proposed modifications with rationale, synthesizing variants based on the proposed modifications, and evaluating the variants against the qualitative evaluation criteria.

8. A computer-implemented method for hypothesis-driven optimization of multi-agent systems, the method comprising:
receiving an input defining objectives for a target multi-agent system;
generating a multi-agent system definition comprising a plurality of agent definition data structures, each agent definition data structure comprising a role parameter, a goal parameter, a backstory parameter expressed in natural language, and a task parameter;
executing the multi-agent system definition to produce execution outputs;
evaluating the execution outputs against qualitative evaluation criteria using a large language model;
generating hypothesis data comprising proposed modifications to at least one of the backstory parameter, agent roles, agent goals, agent tasks, or inter-agent dependencies, the hypothesis data further comprising rationale identifying why each proposed modification is expected to yield improved performance relative to the qualitative evaluation criteria;
synthesizing a plurality of variant multi-agent system definitions, each variant implementing a different combination of the proposed modifications;
executing and evaluating the plurality of variant multi-agent system definitions against the qualitative evaluation criteria;
ranking the plurality of variant multi-agent system definitions based on the qualitative evaluation criteria; and
storing a reference multi-agent system definition corresponding to a top-performing variant for use in a subsequent optimization iteration.

9. A system for autonomous generation and optimization of a target multi-agent system, the system comprising:
one or more processors; and
a memory storing instructions that, when executed by the one or more processors, cause the system to:
   receive an input comprising at least one of: (i) data identifying a set of available computational tools, (ii) an idea description defining objectives, or (iii) an existing multi-agent system implementation;
   generate a multi-agent system definition comprising a plurality of agent definition data structures, each agent definition data structure comprising:
      a role parameter defining a function and responsibilities of a corresponding agent within the target multi-agent system,
      a goal parameter specifying objectives that the corresponding agent is designed to achieve,
      a backstory parameter expressed in natural language that defines an expertise domain, a behavioral context, and a decision-making rationale for the corresponding agent, wherein the backstory parameter influences runtime behavior of the corresponding agent by shaping how the agent interprets tasks, generates outputs, and interacts with other agents,
      a task parameter specifying assigned operations and expected outputs for the corresponding agent, and
      dependency and delegation references defining inter-agent relationships and task delegation strategies;
   generate qualitative evaluation criteria by analyzing the multi-agent system definition using a large language model, wherein the qualitative evaluation criteria are derived without requiring human-specified evaluation parameters, and wherein the qualitative evaluation criteria comprise at least two of: relevance, clarity, consistency, completeness, and depth of analysis;
   iteratively optimize the multi-agent system definition by generating hypothesis data comprising proposed modifications with rationale, synthesizing variants based on the proposed modifications, and evaluating the variants against the qualitative evaluation criteria, wherein the rationale identifies why each proposed modification is expected to yield improved performance relative to the qualitative evaluation criteria; and
   store, using a memory module, a reference multi-agent system definition and maintain a version history of multi-agent system definitions across optimization iterations.

13. The system of clause 1, wherein the backstory parameter defines an expertise domain, a behavioral context, and a decision-making rationale for a corresponding agent.

14. The system of clause 1, wherein the qualitative evaluation criteria are derived without requiring human-specified evaluation parameters.

15. The system of clause 1, wherein the hypothesis data further comprises rationale identifying why each proposed modification is expected to yield improved performance relative to the qualitative evaluation criteria.

16. The system of clause 1, wherein synthesizing variants comprises generating a plurality of variant multi-agent system definitions, each variant implementing a different combination of the proposed modifications.

17. The system of clause 1, wherein evaluating the variants comprises ranking the plurality of variant multi-agent system definitions based on the qualitative evaluation criteria.

18. The system of clause 1, further comprising a memory module configured to store a reference multi-agent system definition and maintain a version history of multi-agent system definitions across optimization iterations.

19. The system of clause 1, wherein the system operates autonomously without human intervention to generate the multi-agent system definition, generate the qualitative evaluation criteria, and iteratively optimize, until a termination condition is satisfied.

20. The system of clause 19, wherein the termination condition comprises at least one of: a predefined performance threshold being met, a maximum iteration count being reached, or performance improvement falling below a threshold across successive iterations.

21. The system of clause 1, further configured to receive optional human input at predefined intervention points, wherein the system operates fully autonomously in absence of the optional human input.

22. The system of clause 1, wherein the input comprises at least one of: (i) data identifying a set of available computational tools, (ii) an idea description defining objectives, or (iii) an existing multi-agent system implementation.

23. The system of clause 4, wherein the backstory parameter influences runtime behavior of the corresponding agent by shaping how the agent interprets tasks, generates outputs, and interacts with other agents.

24. The system of clause 4, wherein each agent definition data structure further comprises a role parameter, a goal parameter, and a task parameter.

25. The system of clause 4, wherein each agent definition data structure further comprises dependency and delegation references defining inter-agent relationships and task delegation strategies.

26. The system of clause 4, wherein the proposed modifications target at least one of: the backstory parameter, agent roles, agent goals, agent tasks, or inter-agent dependencies.

27. The system of clause 5, wherein, when the input comprises data identifying the set of available computational tools, generating the multi-agent system definition comprises: analyzing capabilities of the available computational tools; autonomously generating candidate enterprise use-cases implementable using the available computational tools; evaluating the candidate enterprise use-cases for technical feasibility and commercial viability; and synthesizing the plurality of agent definition data structures for a validated candidate enterprise use-case.

28. The system of clause 5, wherein, when the input comprises the idea description, generating the multi-agent system definition comprises synthesizing the plurality of agent definition data structures based on objectives defined in the idea description.

29. The system of clause 5, wherein, when the input comprises the existing multi-agent system implementation, generating the qualitative evaluation criteria comprises analyzing source code or workflow logic of the existing multi-agent system implementation to infer objectives and deriving the qualitative evaluation criteria from the inferred objectives.

30. The system of clause 6, wherein evaluating the candidate enterprise use-cases for technical feasibility comprises evaluating based on technical constraints including availability of required computational tools, compatibility of tool integrations, and framework support.

31. The system of clause 6, wherein evaluating the candidate enterprise use-cases for commercial viability comprises evaluating based on commercial considerations including scalability, return on investment potential, and market demand.

32. The system of clause 6, further comprising an innovation agent configured to generate disruptive business models by tracking emerging trends and technologies, and a feasibility agent configured to evaluate technical and commercial feasibility of generated ideas.

33. The method of clause 7, wherein the qualitative evaluation criteria comprise at least two of: relevance, clarity, consistency, completeness, and depth of analysis.

34. The method of clause 7, wherein analyzing the source code or workflow logic comprises extracting objectives from agent role definitions, goal parameters, and task specifications in the existing multi-agent system implementation.

35. The method of clause 8, wherein the rationale documents reasoning behind each proposed modification and expected improvements resulting from the modification.

36. The method of clause 8, further comprising generating an audit record for each optimization iteration, the audit record comprising: hypothesis data tested, modifications applied, evaluation outcomes, comparison results, and selection decisions with supporting rationale.

37. The method of clause 8, wherein the qualitative evaluation criteria are generated by analyzing source code or workflow logic of the multi-agent system definition to extract objectives and deriving the qualitative evaluation criteria from the extracted objectives using the large language model.

56. A system for autonomous market research multi-agent system generation and optimization, the system comprising:
one or more processors; and
a memory storing instructions that, when executed by the one or more processors, cause the system to:
   receive an input defining market research objectives;
   generate a multi-agent system definition comprising a plurality of agent definition data structures configured for market research operations, each agent definition data structure comprising a backstory parameter expressed in natural language that defines expertise in market analysis, competitive intelligence, or consumer research;
   generate qualitative evaluation criteria by analyzing the multi-agent system definition using a large language model, wherein the qualitative evaluation criteria are derived without requiring human-specified evaluation parameters; and
   iteratively optimize the multi-agent system definition by generating hypothesis data comprising proposed modifications with rationale, synthesizing variants based on the proposed modifications, and evaluating the variants against the qualitative evaluation criteria.

57. A system for autonomous business process automation multi-agent system generation and optimization, the system comprising:
one or more processors; and
a memory storing instructions that, when executed by the one or more processors, cause the system to:
   receive an input defining business process automation objectives;
   generate a multi-agent system definition comprising a plurality of agent definition data structures configured for business process automation, each agent definition data structure comprising a backstory parameter expressed in natural language that defines expertise in workflow orchestration, task management, or process optimization;
   generate qualitative evaluation criteria by analyzing the multi-agent system definition using a large language model, wherein the qualitative evaluation criteria are derived without requiring human-specified evaluation parameters; and
   iteratively optimize the multi-agent system definition by generating hypothesis data comprising proposed modifications with rationale, synthesizing variants based on the proposed modifications, and evaluating the variants against the qualitative evaluation criteria.

58. A system for autonomous report generation multi-agent system generation and optimization, the system comprising:
one or more processors; and
a memory storing instructions that, when executed by the one or more processors, cause the system to:
   receive an input defining report generation objectives;
   generate a multi-agent system definition comprising a plurality of agent definition data structures configured for report generation, each agent definition data structure comprising a backstory parameter expressed in natural language that defines expertise in data analysis, content synthesis, or presentation;
   generate qualitative evaluation criteria by analyzing the multi-agent system definition using a large language model, wherein the qualitative evaluation criteria are derived without requiring human-specified evaluation parameters; and
   iteratively optimize the multi-agent system definition by generating hypothesis data comprising proposed modifications with rationale, synthesizing variants based on the proposed modifications, and evaluating the variants against the qualitative evaluation criteria.

1. A system for an autonomous generation and optimization of a target multi-agent system, the system comprising:
one or more processors; and
a memory storing instructions that, when executed by the one or more processors, cause the system to:
receive, as an input, an idea description defining objectives for a target multi-agent system,
generate a multi-agent system definition comprising a plurality of agent definition data structures, each agent definition data structure comprising a backstory parameter expressed in natural language that defines an expertise domain, a behavioral context, and a decision-making rationale for a corresponding agent;
generate qualitative evaluation criteria by analyzing the multi-agent system definition using a large language model, wherein the qualitative evaluation criteria are derived without requiring human-specified evaluation parameters; and
iteratively optimize the multi-agent system definition by generating hypothesis data comprising proposed modifications with rationale, synthesizing variants based on the proposed modifications, and evaluating the variants against the qualitative evaluation criteria.

2. The system of claim 1, wherein, when the input comprises data identifying a set of available computational tools, generating the multi-agent system definition comprises:
analyzing capabilities of the available computational tools; autonomously generating candidate enterprise use-cases implementable using the available computational tools;
evaluating the candidate enterprise use-cases for technical feasibility and commercial viability; and
synthesizing the plurality of agent definition data structures for a validated candidate enterprise use-case.

3. The system of claim 1, wherein, when the input comprises the idea description, generating the multi-agent system definition comprises synthesizing the plurality of agent definition data structures based on objectives defined in the idea description, each agent definition data structure further comprising a role parameter, a goal parameter, and a task parameter.

4. The system of claim 1, wherein, when the input comprises an existing multi-agent system implementation, generating the qualitative evaluation criteria comprises analyzing source code or workflow logic of the existing multi-agent system implementation to infer objectives and deriving the qualitative evaluation criteria from the inferred objectives.

5. The system of claim 1, wherein, when the input comprises an existing multi-agent system implementation, generating the qualitative evaluation criteria comprises analyzing source code or workflow logic of the existing multi-agent system implementation to infer objectives and deriving the qualitative evaluation criteria from the inferred objectives.

6. The system of claim 1, wherein the rationale in the hypothesis data identifies why each proposed modification is expected to yield improved performance relative to the qualitative evaluation criteria, and wherein the proposed modifications target at least one of: the backstory parameter, agent roles, agent goals, agent tasks, and inter-agent dependencies.

7. The system of claim 1, wherein synthesizing variants comprises generating a plurality of variant multi-agent system definitions, each variant implementing a different combination of proposed modifications, and wherein evaluating comprises ranking the plurality of variants based on the qualitative evaluation criteria.

8. The system of claim 1, further comprising a memory module configured to store a reference multi-agent system definition and maintain a version history of multi-agent system definitions across optimization iterations.

9. The system of claim 1, wherein the system operates autonomously without human intervention to generate the multi-agent system definition, generate the qualitative evaluation criteria, and iteratively optimize, until a termination condition is satisfied, wherein the termination condition comprising at least one of: a predefined performance threshold being met, a maximum iteration count being reached, and performance improvement falling below a threshold across successive iterations.

10. The system of claim 1, wherein generating the multi-agent system definition comprises:
determining, based on the idea description, a number and types of agents required for the target multi-agent system;
for each agent, generating: a role parameter defining an agent's function, a goal parameter defining success criteria, the backstory parameter as a natural language description defining expertise domain, behavioral context, and decision-making rationale, and a task parameter defining assigned operations and expected outputs; and
defining inter-agent dependencies and delegation strategies.

11. The system of claim 1, wherein the qualitative evaluation criteria are inferred by the large language model by:
analyzing source code or workflow logic of the target multi-agent system;
extracting objectives from the analyzed source code or workflow logic; and
deriving the qualitative evaluation criteria from the extracted objectives, the qualitative evaluation criteria comprising at least two of: relevance, clarity, consistency, completeness, and depth of analysis.

12. The system of claim 1, further comprising a documentation module configured to generate audit records for each optimization iteration, the audit records comprising: hypothesis data tested, modifications applied, evaluation outcomes, comparison results, and selection decisions with supporting rationale.

13. The system of claim 1, further comprising an innovation module configured to:
receive data identifying a set of available computational tools;
autonomously generate candidate enterprise use-cases implementable using the set of available computational tools;
evaluate each candidate enterprise use-case for technical feasibility and commercial viability; and
provide a validated candidate enterprise use-case as the idea description.

14. A computer-implemented method for autonomous generation and optimization of multi-agent systems, comprising:
receiving an input comprising at least one of: (i) data identifying a set of available computational tools, (ii) an idea description defining objectives, or (iii) an existing multi-agent system implementation;
generating a multi-agent system definition comprising a plurality of agent definition data structures, each agent definition data structure comprising a backstory parameter expressed in natural language that defines an expertise domain, a behavioral context, and a decision-making rationale for a corresponding agent;
generating qualitative evaluation criteria by analyzing the multi-agent system definition using a large language model, wherein the qualitative evaluation criteria are derived without requiring human-specified evaluation parameters; and
iteratively optimizing the multi-agent system definition by generating hypothesis data comprising proposed modifications with rationale, synthesizing variants based on the proposed modifications, and evaluating the variants against the qualitative evaluation criteria.

15. The method of claim 14, wherein, when the input comprises data identifying the set of available computational tools, generating the multi-agent system definition comprises:
analyzing capabilities of the available computational tools; autonomously generating candidate enterprise use-cases; evaluating the candidates for technical feasibility and commercial viability; and synthesizing the plurality of agent definition data structures for a validated candidate.

16. The method of claim 14, wherein the rationale in the hypothesis data identifies why each proposed modification is expected to yield improved performance, and wherein the proposed modifications target at least one of: the backstory parameter, agent roles, agent goals, agent tasks, and inter-agent dependencies.

17. The method of claim 14, wherein synthesizing variants comprises generating a plurality of variants, each implementing a different combination of proposed modifications, and wherein evaluating comprises ranking the plurality of variants.

18. The method of claim 14, further comprising storing a reference multi-agent system definition and maintaining a version history across optimization iterations.

19. The method of claim 14, wherein the method operates autonomously without human intervention until a termination condition is satisfied.

20. The method of claim 14, wherein the qualitative evaluation criteria comprise at least two of: relevance, clarity, consistency, completeness, and depth of analysis.
